(19) United States
(12) Patent Application Publication
(10) Pub. No.: US 2010/0199284 A1
(43) Pub. Date: Aug. 5, 2010

(54) INFORMATION PROCESSING APPARATUS, SELF-TESTING METHOD, AND STORAGE MEDIUM

(75) Inventor: Keiji SHIMATANI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/758,308

(22) Filed: Apr. 12, 2010

Related U.S. Application Data
(63) Continuation of application No. PCT/JP2007/001123, filed on Oct. 16, 2007.

(51) Int. Cl. G06F 9/50

(52) U.S. Cl. 718/103; 718/104

(57) ABSTRACT

An information processing apparatus includes: a storage unit; testing units; read units that respectively read priority information, class information, and progress information from the storage unit; and an assignment unit that assigns an unexecuted testing process to a testing unit according to the read information, and that rewrites the progress information according to assignment of the unexecuted testing process. The testing units executes testing processes of the information processing apparatus. The priority information indicates a priority defined according to dependency among the testing processes in executing the testing processes. The class information associates a class with each testing process and indicates a range of the testing unit(s) to execute the associated testing process. The progress information indicates which testing process is uncompleted.

### CROSS-REFERENCE TO RELATED APPLICATIONS

This application is a continuation of PCT application PCT/JP2007/001123, which was filed on Oct. 16, 2007, and the entire contents of which are incorporated herein by reference.

### FIELD

A certain aspect of the embodiments discussed herein is related to an information processing apparatus, a self-testing method, and a storage medium.

### BACKGROUND

When a computer is powered on or reset, various device tests are performed or executed by a kind of firmware. The tests by the firmware are referred to as POSTs (Power On Self Tests).

In an apparatus having a plurality of CPUs (Central Processing Units), the plurality of CPUs normally share and perform the POSTs. Depending on the types of tests, exclusive control may be required to assign a test or tests to be performed to each CPU.

For example, the patent document 1 describes a method applied to a computer system in which a storage device is shared by a plurality of CPUs. The method is for controlling the execution of test programs requiring a test environment in which the resources in the system are occupied.

The control method described in the patent document 1 includes logically dividing a memory area, assigning a divided memory area to each CPU, and loading a monitor program for controlling the execution of a test program into each memory area. Then, the monitor program realizes exclusive control to prevent one test program from simultaneously executed by a plurality of CPUs.

However, there is the case in which it is desirable to perform or execute not simple and uniform exclusive control but exclusive control within a range depending on a hardware configuration. In addition, it is generally desirable to consider the restrictions on the execution order of tests in assigning a test or tests to be performed or executed to each CPU.

[Patent Document 1] Japanese Laid-open Patent Publication No. 10-49397

### SUMMARY

According to an aspect of the invention, an information processing apparatus includes a storage unit, a plurality of testing units, a priority information read unit, a class information read unit, a progress information read unit, and an assignment unit.

The plurality of testing units execute a plurality of testing processes of the information processing apparatus.

The priority information read unit reads priority information indicating a priority defined according to dependency among the plurality of testing processes in executing the plurality of testing processes from the storage unit. The class information read unit reads class information associating a class with each testing process and indicating a range of the testing unit or of the testing units to execute the associated testing process from the storage unit. The progress information read unit reads progress information indicating which testing process is uncompleted among the plurality of testing processes from the storage unit.

The assignment unit assigns an unexecuted testing process to any of the plurality of testing units according to the priority information, the class information, and the progress information, and rewrites the progress information according to assignment of the unexecuted testing process.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of a hardware configuration of a server apparatus in which a plurality of testing processes are performed;

FIG. 2 illustrates a test order table used in a comparison example;

FIG. 3 is a timing chart for assignment in a comparison example;

FIG. 4 is a functional block diagram of the assignment device in an embodiment;

FIG. 5 illustrates an example of a grouping table;

FIG. 6 illustrates an example of a priority table;

FIG. 7 illustrates an example of a progress management table of an initial state;

FIG. 8 is a flowchart for assignment in an embodiment;

FIG. 9 is a flowchart of checking a priority order in an embodiment;

FIG. 10 is a flowchart of the process of rewriting a progress management table immediately before performing a test according to an embodiment;

FIG. 11 is a flowchart of the process of rewriting a progress management table immediately after performing a test according to an embodiment;

FIG. 12 is a timing chart for assignment in an embodiment; and

FIGS. 13A through 13H illustrate the states of a progress management table according to an embodiment, respectively.

### DESCRIPTION OF EMBODIMENTS

The embodiments are described below in detail with reference to the attached drawings.

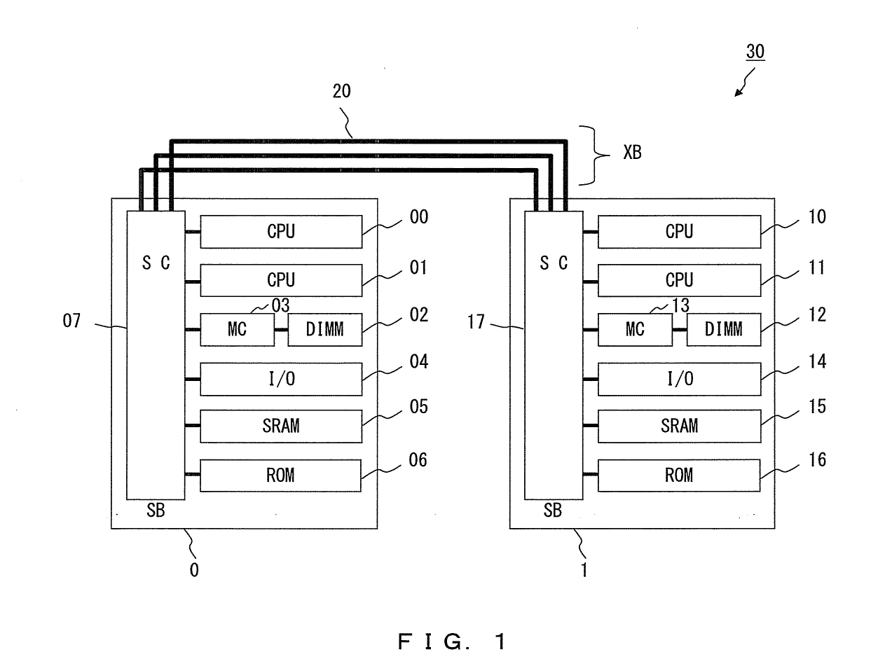

The description is given in the following order. First, a comparison example is described with reference to FIGS. 1 through 3 to support understanding the merits of the embodiments described later.

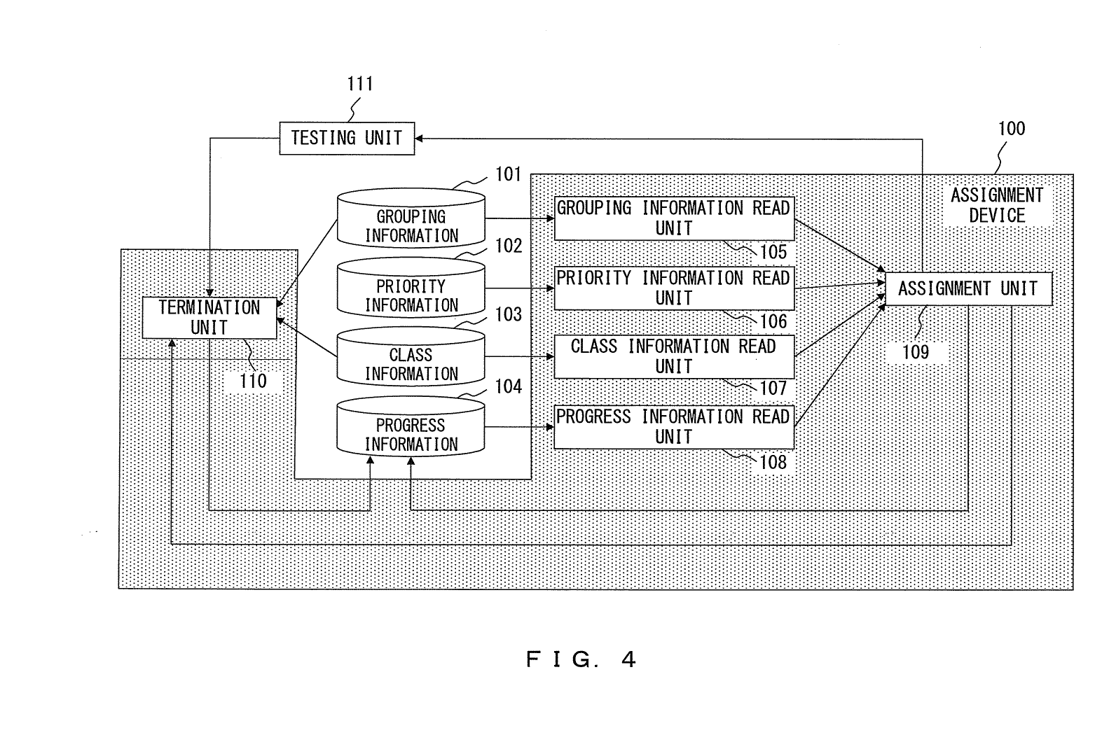

Then, the outline of the assignment device according to an embodiment is described with reference to FIG. 4 as a functional block diagram of the assignment device according to an embodiment. Next, with reference to FIG. 1 again, the configuration of the hardware of the server apparatus as an example of an apparatus including the hardware for realizing an assignment device and the hardware to be tested is described.

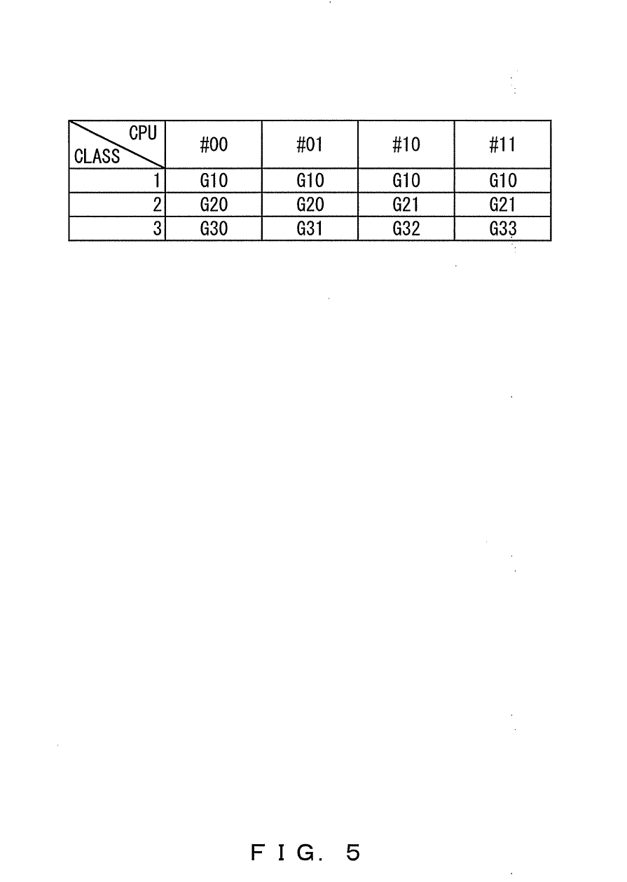

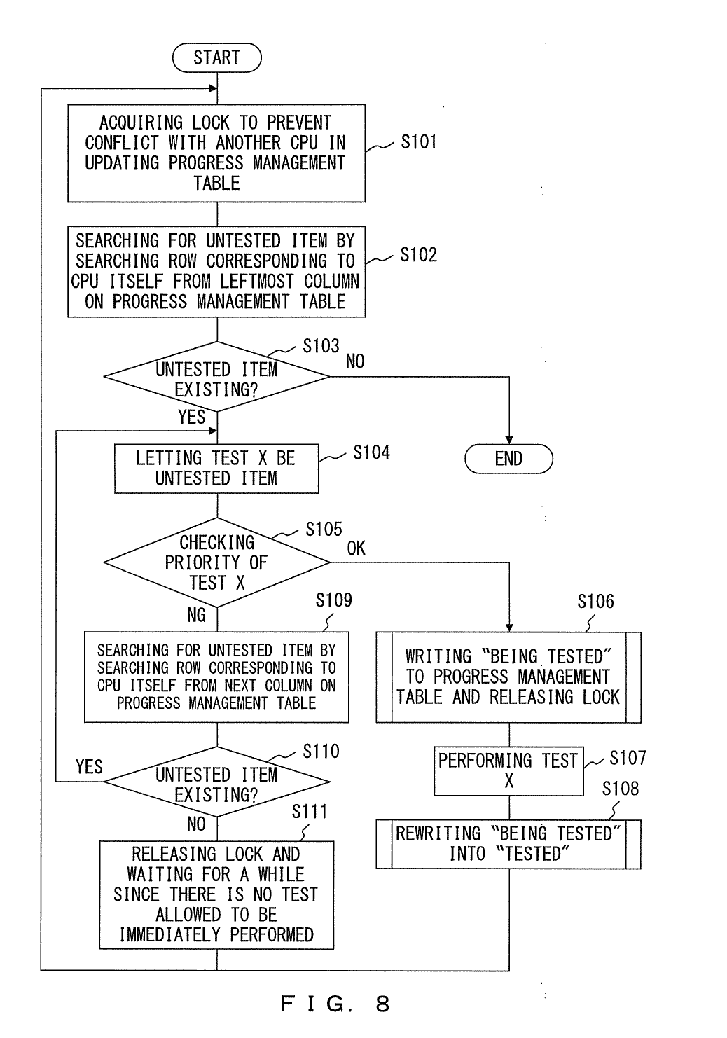

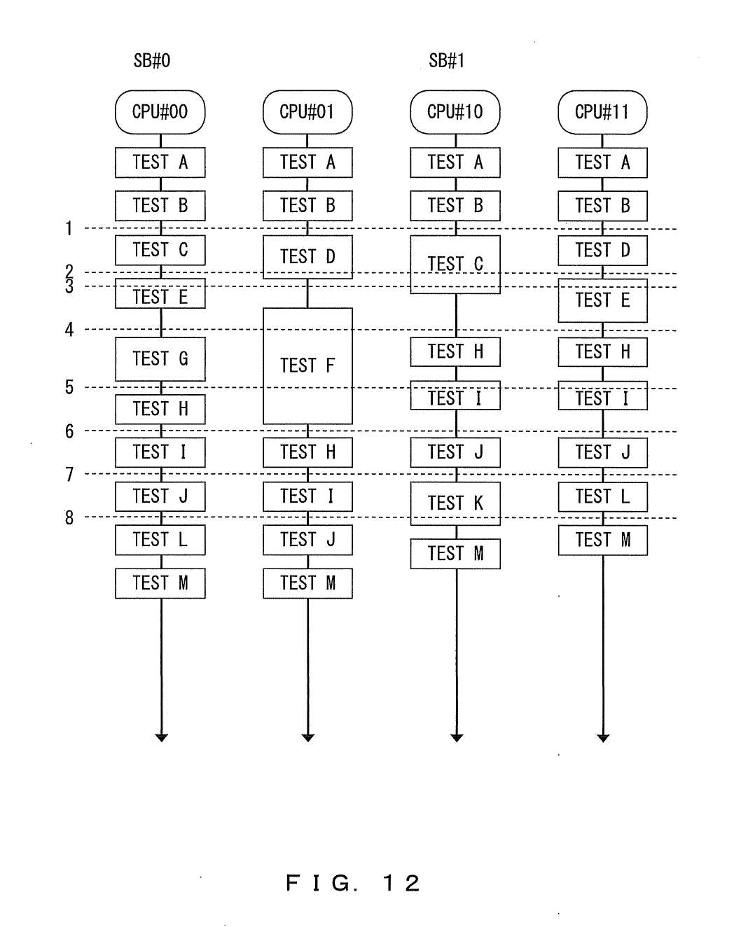

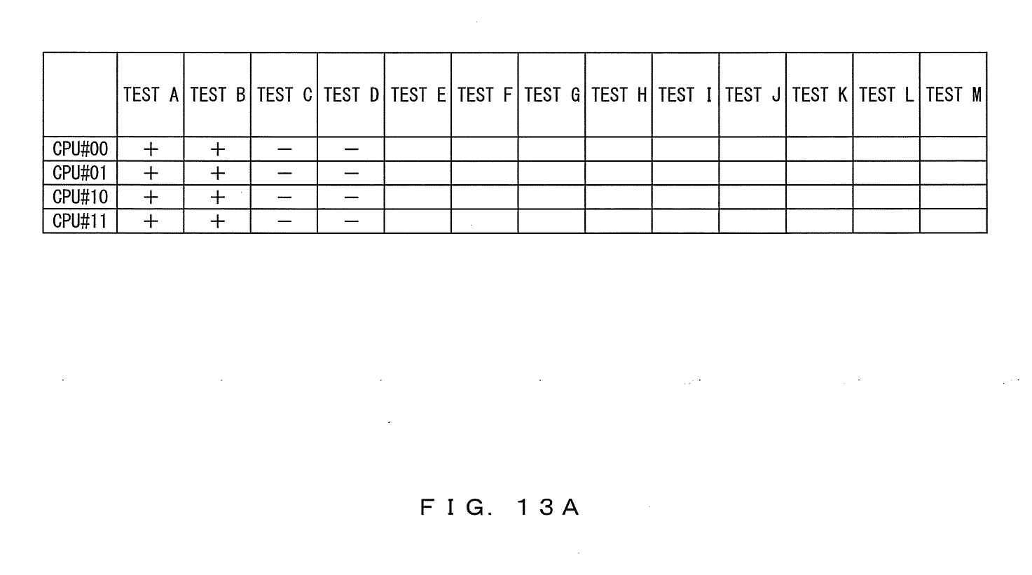

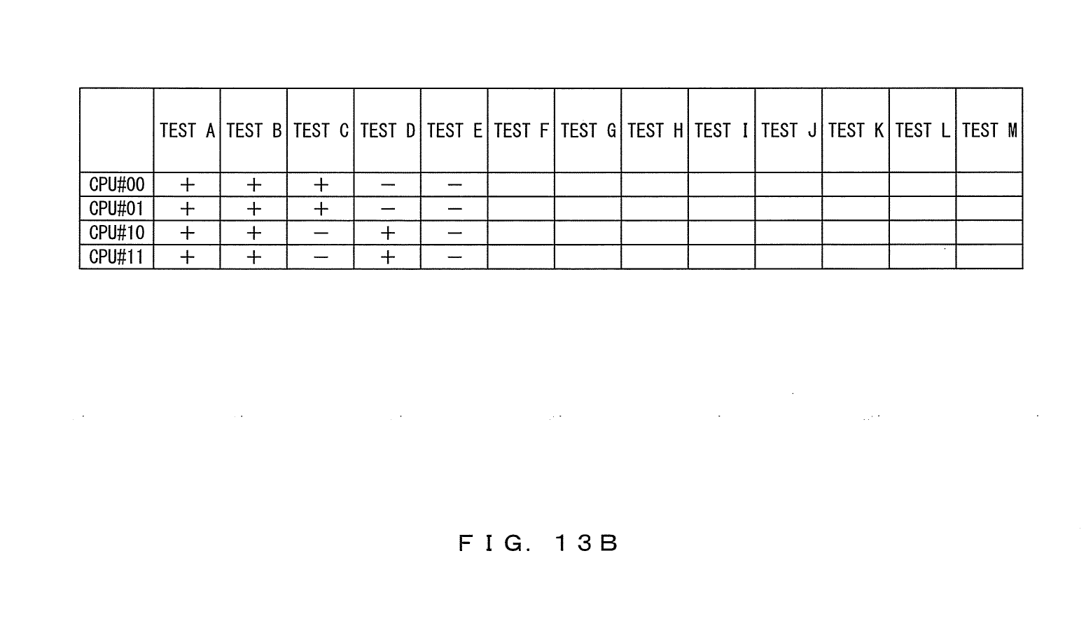

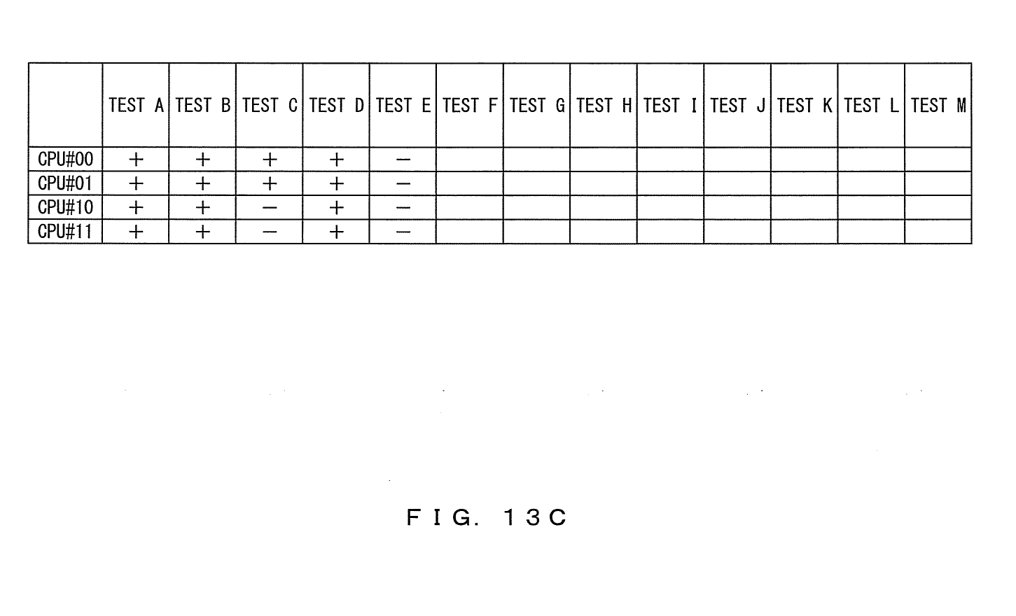

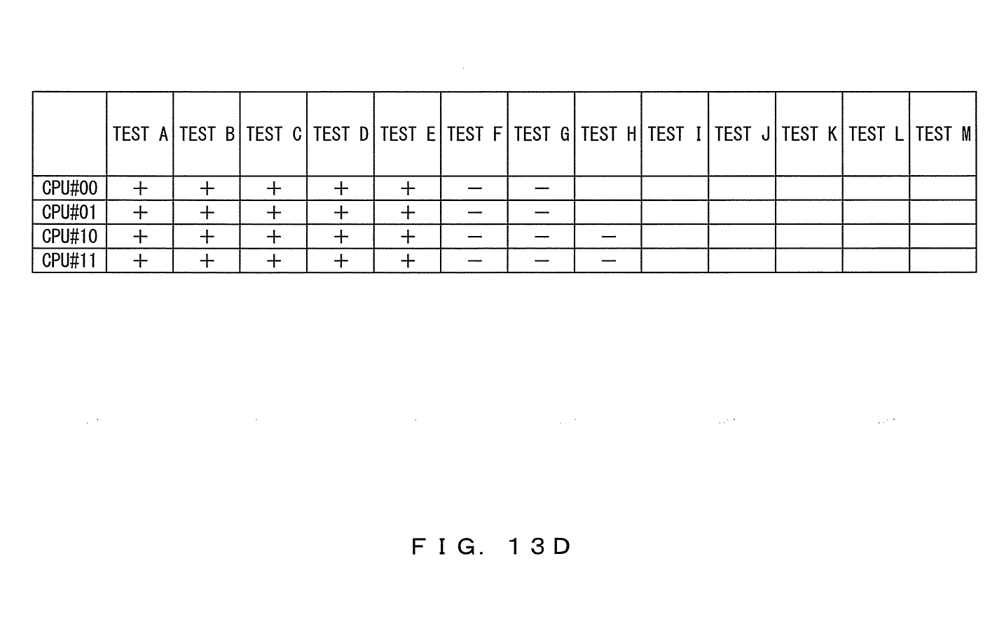

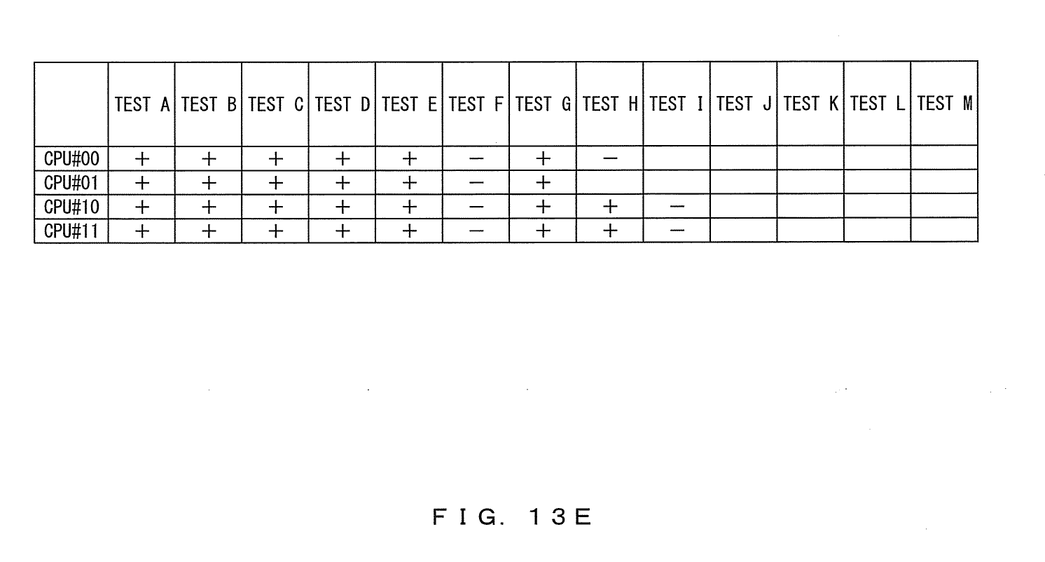

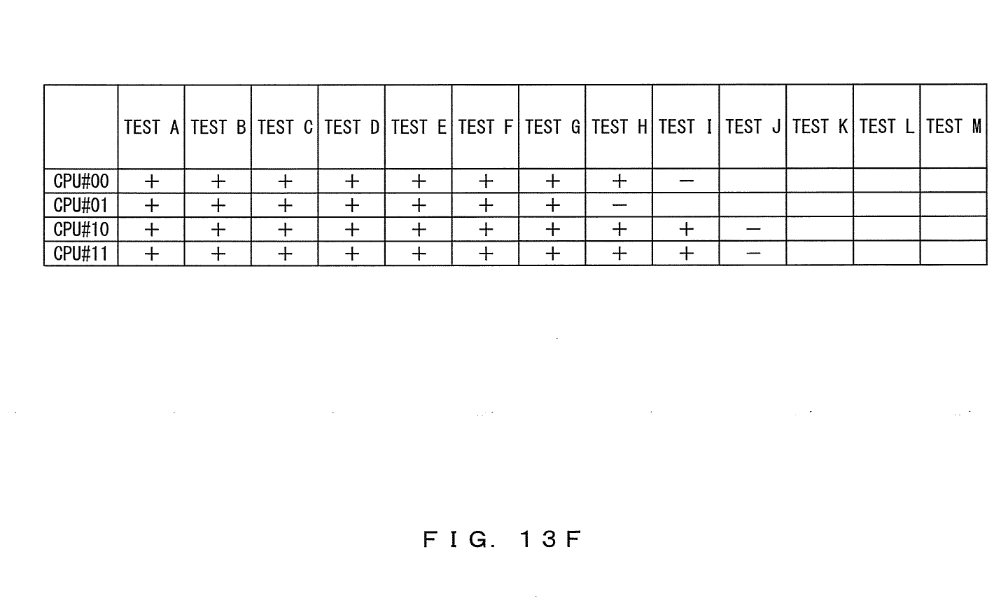

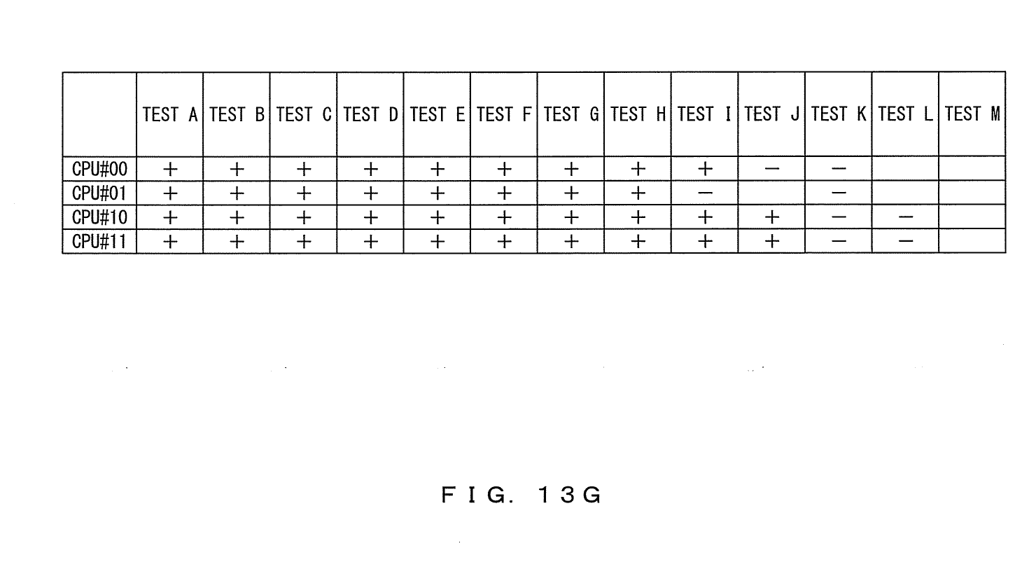

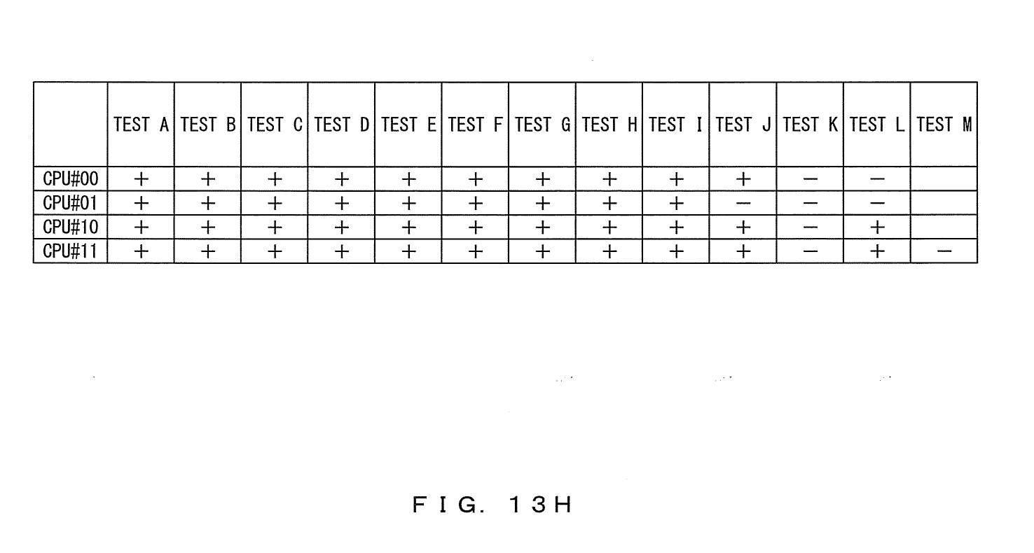

Next, with reference to FIGS. 5 through 7, the classes of tests and examples of various tables used in assigning a testing process are described. Then, with reference to the flowcharts in FIGS. 8 through 11, an assigning method according to an embodiment is described. Subsequently, with reference to the timing chart in FIG. 12 and with reference to FIGS. 13A through 13H illustrating the transition of data, a concrete example of assignment is described. Described finally are examples of modified embodiments.

Before describing the embodiments, a comparison example is described with an exemplary case of an application to a server apparatus 30 having a hardware configuration illustrated in FIG. 1. The present comparison example is an example of assigning a test or tests to be performed or executed to each CPU by considering both restrictions as to whether or not a plurality of CPUs are allowed to repeatedly or concurrently perform the same test, and restrictions on the execution order of tests.

The server apparatus 30 in FIG. 1 has a configuration in which two circuit boards are connected by a crossbar switch (hereinafter referred to as an XB for short) 20. The circuit board provided for the server apparatus 30 is referred to as a system board, and is abbreviated as an SB.

An SB 0 is provided with a CPU 00, a CPU 01, a DIMM (Dual Inline Memory Module) 02, an MC (Memory Controller) 03 for controlling a write of data to the DIMM 02 and a read of data from the DIMM 02, an input and output unit (abbreviated as an I/O) 04, SRAM (Static Random Access Memory) 05, ROM (Read Only Memory) 06, and a control unit (hereinafter referred to as a system controller, and abbreviated as an SC) 07. An SB 1 has configuration similar to the SB 0.

The SC 07 on the SB 0 is connected to the CPU 00, the CPU 01, the MC 03, the I/O 04, the SRAM 05, and the ROM 06, all of which are on the SB 0, via a bus. The SC 07 controls the data transfer among the units in the SB, and also controls the data transfer with the SB 1 through the XB 20. An SC 17 on the SB 1 is similar to the SC 07.

For example, when the CPU 00 on the SB 0 reads data from a DIMM 12 on the SB 1, the data is read under the control by the SC 07 on the SB 0 and by the SC 17 on the SB 1. That is, the data is read from the DIMM 12 on the SB 1, transmitted to the SC 17 through an MC 13, transmitted to the SB 0 through the XB 20, and transmitted from the SC 07 to the CPU 00 on the SB 0.

Hereinafter, let the range in which data can be transferred as exemplified above be called a “domain”. For example, the entire server apparatus 30 is one domain in FIG. 1 because the units in each SB are connected via a bus, and the SB 0 and the SB 1 are connected to each other through the XB 20.

In the above-mentioned server apparatus 30 in FIG. 1, when a test or tests to be conducted is/are assigned to each CPU, the following first and second requirements are to be considered.

The first requirement is to perform exclusive control depending on the nature of a test. Practically, tests are classified into the following three classes depending on the nature of the tests.
class 1: class of the test performed by only one CPU in one domain
class 2: class of the test performed by only one CPU in one SB
class 3: class of the test performed by each CPU

The test of class 1 is mainly targeted at the portion peculiar to a domain. For example, the test targeted at the XB 20 may be appropriately classified as class 1.

The test of class 2 is mainly targeted at the portion peculiar to an SB. For example, the test targeted at the hardware such as a DIMM or an I/O, which is provided for each SB, may be appropriately classified as class 2.

The test of class 3 is mainly targeted at each CPU. For example, it is normally hard to access a register or cache memory in the CPU 00 from other CPUs. Accordingly, the register and the cache memory in the CPU 00 may be tested not by other CPUs but by the CPU 00 itself. Therefore, the test targeted at the register, the cache memory, etc. in the CPU may be appropriately classified as class 3.

According to the above-mentioned classification, the first requirement is described as follows. That is, the first requirement is to perform the exclusive control so as to prevent the test of class 1 from being redundantly (in other words, repeatedly or concurrently) performed by a plurality of CPUs in one domain, and so as to prevent the test of class 2 from being redundantly performed by a plurality of CPUs in one SB. On the other hand, the first requirement also indicates that the exclusive control among the CPUs is not required in the test of class 3.

The second requirement is to perform tests in the order that is determined according to a certain factor such as the dependency among the tests.

For example, the test of the cache memory in a CPU includes an operation for reading data from a DIMM used as main memory and writing the data to cache memory, and an operation for reading data from cache memory and writing the data to a DIMM. That is, it is necessary for the test of the cache memory to write and read data to and from a DIMM. Therefore, before performing a test on cache memory, it is necessary to perform a test on a DIMM and confirm that data can be normally written and read to and from the DIMM.

To satisfy the first and second requirements, the following method is used in the present comparison example.

First to satisfy the first requirement, one CPU in a domain is statically selected in advance as a “domain master CPU”, and one CPU in each SB is statically selected in advance as an “SB master CPU”.

It is prohibited that a CPU other than the domain master CPU performs a test of class 1. It is also prohibited that a CPU other than the SB master CPU performs a test of class 2.

Note that the test of class 2 that is allowed to be performed by the SB master CPU is limited to the test on the SB including the SB master CPU itself. For example, assume that the SB master CPU in the SB 0 is CPU 00, and the SB master CPU in the SB 1 is a CPU 10. In this case, the CPU 00 performs a test of class 2 targeted at the SB 0, but is not allowed to perform a test of class 2 targeted at the SB 1.

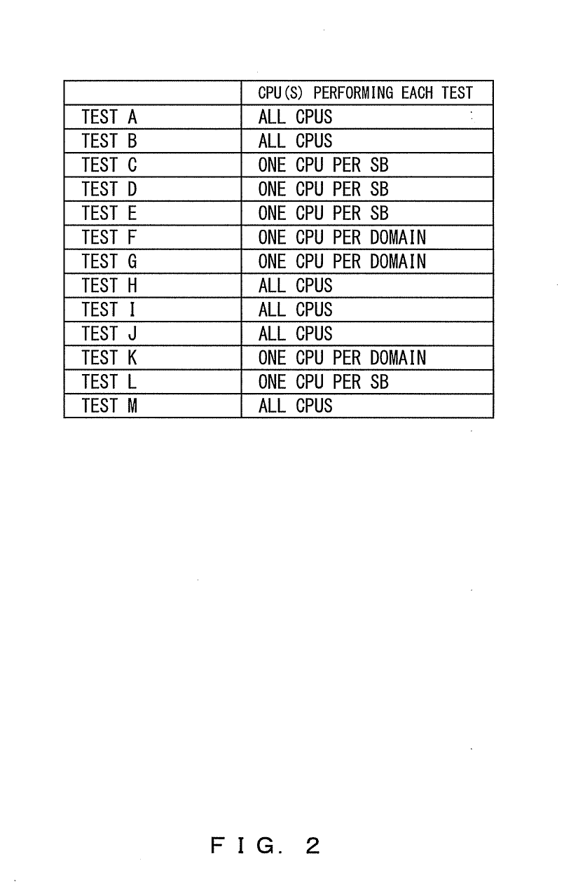

Furthermore, to satisfy the second requirement, a test order table as exemplified in FIG. 2 is prepared in advance, and stored in, for example, the ROM 06 and 16. The test order table in FIG. 2 defines that tests are to be executed in the order described in the test order table.

The test order table in FIG. 2 also includes the information about the first requirement to consider the first and second requirements together. That is, listed on the right column of the test order table are the CPUs for performing the tests listed on the left column. In the table, the notation “one CPU per domain”, the notation “one CPU per SB”, and the notation “all CPUs” respectively refer to classes 1, 2, and 3.

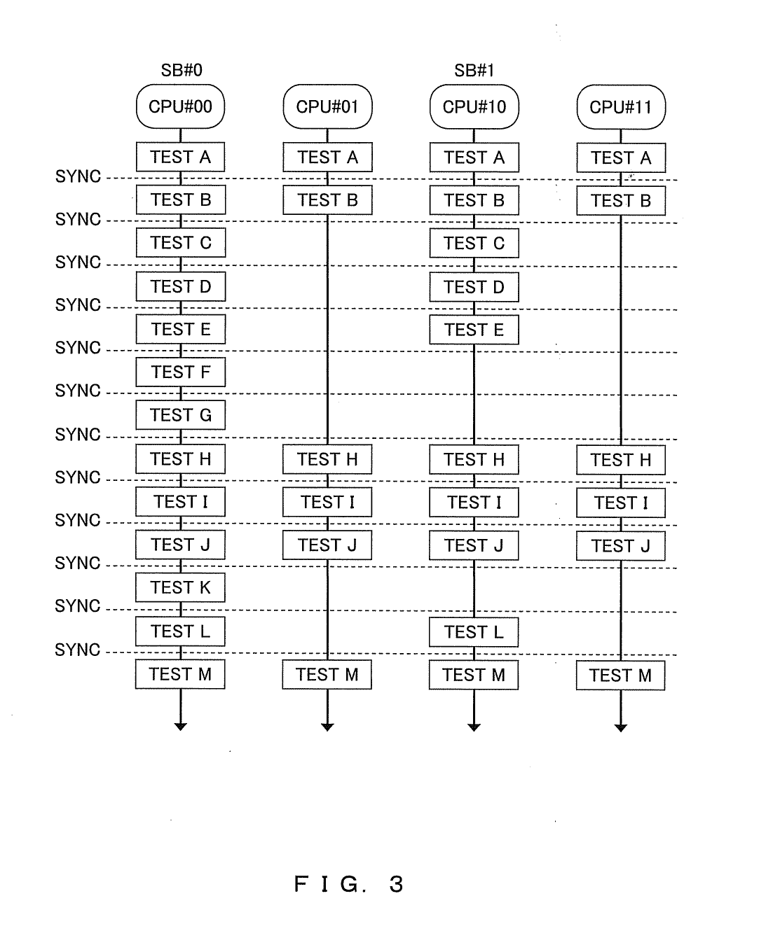

Next, the flow of the testing process in the present comparison example is described below with reference to the timing chart in FIG. 3.

In this example, as illustrated in FIG. 2, the POSTs include the tests A through M. The execution order of the tests A through M is as defined in the test order table illustrated in FIG. 2. The domain master CPU is the CPU 00, the SB master CPU in the SB 0 is CPU 00, and the SB master CPU in the SB 1 is the CPU 10.

In the method of the present comparison example illustrated in FIG. 3, all CPUs synchronize with each other each time one test is terminated in order to satisfy the first requirement. The horizontal dotted lines with “SYNC” in FIG. 3 indicate the timing of synchronization.

The process proceeds as follows. Each of the four CPUs in FIG. 1 refers to the test order table, recognizes that the test to be first performed is the test A, and that the test A is a test of class 3, and performs the test A. When all of the four CPUs terminate performing the test A, the four CPUs synchronize with each other. By this synchronization, the four CPUs recognize that the second test B is now to be performed.

Similarly, the second test B is performed by each of the four CPUs, and then the four CPUs synchronize with each other.

Then, each of the four CPUs refers to the test order table, and recognizes that the third test to be performed is the test C, and that the test C is a test of class 2. According to this recognition, the CPUs 00 and 10 respectively perform the test C, and the CPUs 01 and 11 stand by.

When both CPUs 00 and 10 terminate performing the test C, the four CPUs synchronize with each other, and recognize that the fourth test is now to be performed. Since the fourth test D and fifth test E are tests of class 2, the process proceeds as with the test C.

When both CPUs 00 and 10 terminate performing the test E, the four CPUs synchronize with each other, and recognize that the sixth test is now to be performed. As illustrated in FIG. 2, the sixth test F is a test of class 1.

Therefore, according to the result of the recognition achieved by each CPU referring to the test order table, only the CPU 00 performs the test F, and the CPUs 01, 10, and 11 stand by. Afterwards, when the CPU 00 terminates performing the test F, the four CPUs synchronize with each other, and recognize that the seventh test is now to be performed.

The process proceeds similarly to the above. That is, all CPUs synchronize with each other each time one test is terminated. By repeating the execution of a test and the synchronization thereafter, all tests are terminated upon termination of the execution of the thirteenth test M.

Thus, by referring to the test order table and attaining synchronization, both first and second requirements are satisfied. For example, since the CPU 01 is not an SB master CPU or a domain master CPU, the test to be performed by the CPU 01 next to the test B is the test H. On the other hand, the test H is a test to be performed after the test G. The synchronization makes it possible to prevent the situation in which the CPU 01 starts the test H before the CPU 00 terminates the test G.

However, when the method of the present comparison example is used, a wasteful standby time is taken, thereby requiring an unnecessarily long total testing time because the selection of the domain master CPU and the SB master CPU for satisfying the first requirement is a static selection.

As a result of the static selection, there is time in which processes are concentrated on the domain master CPU and the SB master CPU while other CPUs do not perform testing processes but simply wait for synchronization. For example, in FIG. 3, while the CPU 00 is performing the tests C through G, only the CPU 01 stands by.

The standby time (i.e., the waiting time) as above may be wasteful because of the following reason. There may be no problem when certain two processes are simultaneously performed, but even for such two processes, the execution order is fixedly determined in the test order table in FIG. 2. The fixedly determined execution order disables the above two processes to be performed in parallel. Therefore, wasteful standby time may be taken.

For example, depending on the nature of the tests C and D, practically the tests C and D may be permitted for simultaneous execution. However, the test order table defines that the test C is to be necessarily performed before the test D. In addition, the test order table also defines that a specific CPU statically determined as an SB master CPU is to perform both tests C and D.

Therefore, in the method of the present comparison example, as illustrated in FIG. 3, the statically determined specific CPU is to necessarily perform a statically determined specific test(s) regardless of the state (or, the progress) of performing other test(s) by other CPU(s). However, if it is permitted to simultaneously perform the tests C and D, it is the waste of time for the CPUs 01 and 11 to only wait for the completion of the test C as illustrated in FIG. 3. That is, it is the waste of time for the CPUs 01 and 11 not to perform the test D while the CPUs 01 and 11 performs the test C.

On the other hand, according to the embodiment described below, the total testing time can be shortened by shortening the wasteful standby time while satisfying the following two requirements when a plurality of testing units share and perform a plurality of testing processes. The first requirement is that the exclusive control is to be performed depending on the nature of a test, and the second requirement is that a determined priority in the execution order is to be observed.

FIG. 4 is a functional block diagram of the assignment device 100 in an embodiment. The assignment device 100 assigns a testing process to a testing unit 111 which is one of a plurality of testing units configured to share and perform a plurality of testing processes. FIG. 4 only illustrates the testing unit 111 in the plurality of testing units.

The assignment device 100 and the testing unit 111 may be realized by one CPU, or the assignment device 100 and the testing unit 111 may be realized by physically different devices. In addition, each of the plurality of testing units may be realized by, for example, a plurality of different CPUs.

The assignment device 100 includes a grouping information read unit 105 for reading grouping information 101, a priority information read unit 106 for reading priority information 102, a class information read unit 107 for reading class information 103, a progress information read unit 108 for reading progress information 104, an assignment unit 109 for assigning a testing process to the testing unit 111, and a termination unit 110 for performing post-processing after the testing unit 111 terminates a test.

The practical storage areas of the grouping information 101, the priority information 102, the class information 103 and the progress information 104 are arbitrary. These pieces of information are read by the respective read units through a data transmission path such as a bus and/or an XB, and provided to the assignment unit 109.

For each of a plurality of testing units, the grouping information 101 defines a group to which only the testing unit concerned belongs as a group of the class of the lowest hierarchical level. With respect to a class other than the lowest hierarchical level, the grouping information 101 defines a group including one or more groups of the class immediately below of the class concerned.

Thus, the grouping information 101 defines hierarchical grouping of a plurality of testing units. Each of the plurality of testing units belongs to either one group in each class. A practical example of the grouping information 101 is described later with reference to FIG. 5.

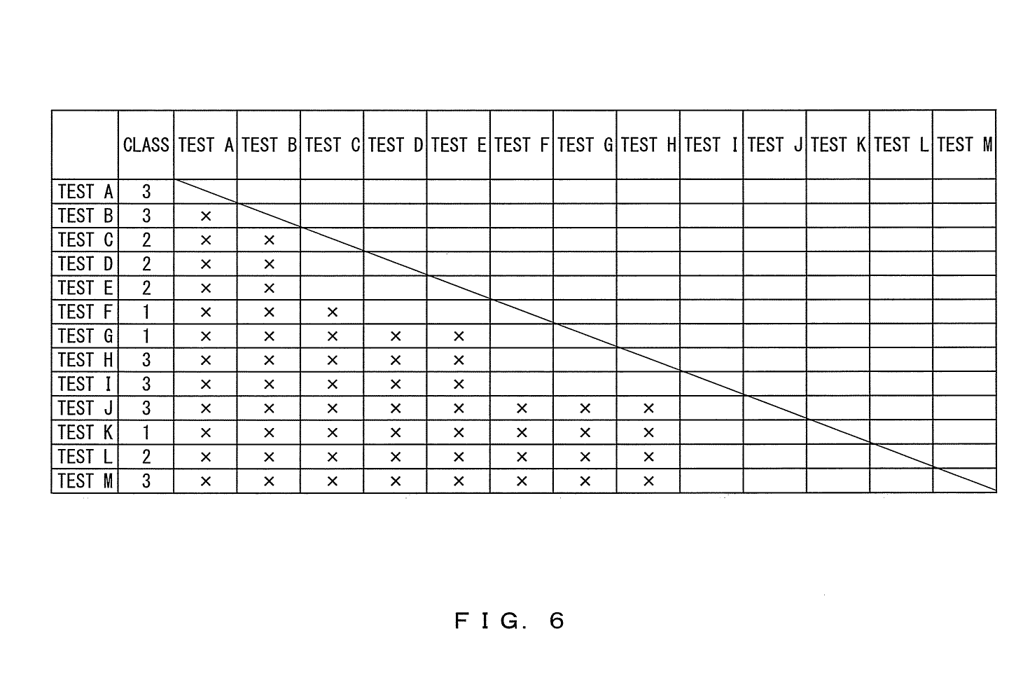

The priority information 102 defines the priority of the execution order for a plurality of testing processes. The priority information 102 indicates for any test X and test Y that the test X is to be performed prior to the test Y, that the test Y is to be performed prior to the test X, or that any one of the test X or the test Y is allowed to be performed prior to the other. A practical example of the priority information 102 is described later with reference to FIG. 6.

The class information 103 associates each of a plurality of testing processes with either of a plurality of classes in the grouping information 101.

For example, the class information 103 for association of test X with class W indicates that the test X is to be performed by only one testing unit in one or more testing units belonging to one group defined in class W. That is, the class information 103 indicates that the range in which the exclusive control on the test X is to be performed is the group of class W. A practical example of the class information 103 is described later with reference to FIG. 6.

The progress information 104 indicates the progress for each combination of each of a plurality of testing units with each of a plurality of testing processes. In the present embodiment, there are three types of progresses “untested”, “being tested”, and “tested”.

The progress “untested” means that the test in question has not yet started (i.e., is unperformed). The progress “being tested” means that the test in question is currently being performed. The progress “tested” means that the test in question has been terminated (i.e., has been completed). The progress “untested” and “being tested” are common in that they mean that the test in question is uncompleted.

As will be described in detail later, the progress related to the combination of the testing unit Z and the test X may not be limited to refer to the progress of the test X by the testing unit Z itself.

For example, the progress “being tested” related to the combination of the testing unit Z and the test X does not indicate that the testing unit Z is currently performing the test X, but indicates that any one (possibly the testing unit Z itself) of the testing unit(s) belonging to the same group as the testing unit Z in the class of the test X is currently performing the test X.

The grouping information 101, the priority information 102, and the class information 103 are static information, but the progress information 104 is dynamic information that is rewritten by the assignment unit 109 and the termination unit 110 and that varies as a result of rewriting.

The assignment unit 109 is provided with the grouping information 101, the priority information 102, the class information 103, and the progress information 104 respectively by the grouping information read unit 105, the priority information read unit 106, the class information read unit 107, and the progress information read unit 108.

The assignment unit 109 selects a testing process assignable to the testing unit 111 according to the provided information. The assignment unit 109 also rewrites the progress information 104 according to the selected testing process, the class information 103, and the grouping information 101. The assignment unit 109 further assigns the selected testing process to the testing unit 111. In addition, the assignment unit 109 notifies the termination unit 110 of the testing process assigned to the testing unit 111.

As described above, in the method of the comparison example, the execution order of a plurality of testing processes is limited to a fixed order in advance, and it is statically predetermined that a specific process is to be performed by a specific CPU. However, since the assignment unit 109 performs the assignment depending on the situation indicated by the progress information 104 in the present embodiment, the standby time of the testing unit 111 can be shortened.

As mentioned above, the testing unit 111 may be an external unit to the assignment device 100, or may be included in the assignment device 100. The testing unit 111 performs the testing process assigned by the assignment unit 109, and notifies the termination unit 110 of the completion of the test when the testing process is terminated.

When the testing unit 111 notifies the termination unit 110 of the completion of the test, the termination unit 110 rewrites the progress information 104 according to the testing process assigned by the assignment unit 109 to the testing unit 111, the class information 103, and the grouping information 101.

A practical example of the operation of the assignment unit 109 and the termination unit 110 is described later with reference to FIGS. 8 through 13H. An outline is described herein.

Since the testing process is assigned according to the progress information 104 dynamically rewritten as described above, the wasteful standby time can be largely shortened in the present embodiment as compared with the comparison example. In addition, since the testing process is assigned also according to the priority information 102, the class information 103, and the grouping information 101, the requirement that the exclusive control is to be performed depending on the nature of a test and the requirement that the priority determined for the execution order is to be observed are satisfied.

Described below is the hardware configuration of the device realizing the assignment device 100 in FIG. 4 according to an embodiment. In the present embodiment, the server apparatus 30 having the configuration illustrated in FIG. 1 realizes the assignment device 100 in FIG. 4.

As described above with reference to FIG. 1, the server apparatus 30 is an apparatus in which the SBs 0 and 1 having similar configurations are connected to each other by the XB 20 as a data transmission path.

Using the XB 20, a one-to-one connection is made between the source and the destination of data, thereby realizing high-speed data transfer. However, in another embodiment, the XB 20 may be replaced with another data transmission path such as a bus etc. The entire server apparatus 30 including two SBs connected to each other by the XB 20 as described above configures one “domain”.

The SB 0 includes the CPUs 00 and 01, the DIMM 02, the MC 03, the I/O 04, the SRAM 05, the ROM 06, and the SC 07. The CPUs 00 and 01, the MC 03, the I/O 04, the SRAM 05, and the ROM 06 are connected to the SC 07 via a bus, and the DIMM 02 is connected to the MC 03 via a bus. The SB 1 has a similar configuration.

Each of the four CPUs 00 through 11 is internally provided with registers, cache memory, etc. The data stored in a register or cache memory of a CPU cannot be directly referenced by another CPU.

The DIMM 02 is used as a working area by the CPUs 00 and 01 in the SB 0, which also includes the DIMM 02 therein. The data transfer between the CPU 00 and the DIMM 02 and between the CPU 01 and the DIMM 02 is controlled by the SC 07 and the MC 03. The same control is performed on the DIMM 12 in the SB 1.

Furthermore, since the SB 0 is connected to the SB 1 by the XB 20, the CPU 10 or 11 on the SB 1, in some cases, reads data stored in the DIMM 02 on the SB 0 or writes data to the DIMM 02. Reversely, the CPU 00 or 01, in some cases, reads data stored in the DIMM 12 or writes data to the DIMM 12.

The I/O 04 has an interface function with various input equipment units such as a keyboard, a pointing device, etc. and various output units such as a display, a speaker, a printer, etc. An I/O 14 has the same function.

The SRAM 05 is used as a working area when the CPUs 00 and 01 execute the firmware whose program code is stored in the ROM 06. In the present embodiment, the program code of the BIOS (Basic Input Output System) as a type of firmware is stored in the ROM 06. When the server apparatus 30 is powered on, some processes including the POSTs are performed by the CPUs 00 and 01 executing the program code of the BIOS. The ROM 06 may be rewritable EPROM (Erasable Programmable Read Only Memory) or flash memory.

The SRAM 15 and the ROM 16 on the SB 1 are respectively similar to the SRAM 05 and the 06.

Furthermore, the SCs 07 and 17 may be connected to a storage device such as a hard disk drive (HDD) etc. not illustrated in the attached drawings.

The difference between the above-mentioned comparison example and the present embodiment is the contents of the program code of the BIOS stored in the ROM 06 and 16. In the program code, the difference lies specifically in a section in which the control relating to the assignment of a plurality of testing processes included in the POSTs is coded. Depending on the difference in program code, four CPUs of the present embodiment have a function different from the function of the comparison example, thereby operating differently from the comparison example.

That is, in the present embodiment, each of the CPUs 00 through 11 in FIG. 1 realizes the functions of the grouping information read unit 105, the priority information read unit 106, the class information read unit 107, the progress information read unit 108, the assignment unit 109, and the termination unit 110 illustrated in FIG. 4. The CPUs 00 and 01 realize the functions of these units by operating according to the program code of the BIOS stored in the ROM 06. The same holds true with the CPUs 10 and 11.

The ROM 06 and 16 are examples of non-transitory computer-readable storage media to store the program code for realizing the respective functions of the units included in the assignment device 100 of FIG. 4. Any other type of non-transitory computer-readable storage medium may also be used to provide the program code.

In the present embodiment, each of the CPUs 00 through 11 illustrated in FIG. 1 also realize the function of the testing unit 111 illustrated in FIG. 4 by operating according to the program code of the BIOS. Therefore, for example, the CPU 00 illustrated in FIG. 1 functions as the assignment device 100 illustrated in FIG. 4, thereby assigning a testing process to the testing unit 111 realized by the CPU 00 itself. Then, the CPU 00 functions as the testing unit 111, i.e., performs the testing process assigned by the CPU 00 itself to the CPU 00 itself. Furthermore, the CPU 00 functions as the assignment device 100, thereby performing post-processing after the execution of the testing process.

In addition, in the present embodiment, the ROM 06 and 16 illustrated in FIG. 1 both store the same priority information 102 and the same class information 103 illustrated in FIG. 4.

Furthermore, both of the SRAM 05 and 15 illustrated in FIG. 1 store the same grouping information 101 illustrated in FIG. 4. Since the grouping information 101 is static information having invariable contents, the CPU 00 may write the contents of the grouping information 101 to the SRAM 05 according to the program code stored in the ROM 06 at a certain time point, for example, immediately after the server apparatus 30 is powered on.

The progress information 104 illustrated in FIG. 4 is distributively stored in the SRAM 05 and 15.

The server apparatus 30 illustrated in FIG. 1 not only realizes the functions of the assignment device 100 and the testing unit 111 illustrated in FIG. 4, but also includes the hardware such as the DIMM 02 etc. to be tested.

Next, the classes of tests in the present embodiment are described below. In the present embodiment, the tests are classified into three classes defined as classes 1 through 3 as follows.
class 1: class of a test to be performed only by one of the CPUs belonging to one domain
class 2: class of a test to be performed only by one of the CPUs belonging to one SB
class 3: class of a test to be performed by each CPU

In the present embodiment, a test targeted at the hardware resources such as the XB 20 etc. shared in a domain is defined as a test of class 1. In addition, a test targeted at the hardware resources such as a DIMM etc. provided for each SB is defined as a test of class 2. A test targeted at the hardware resources such as a register etc. provided for each CPU is defined as a test of class 3.

Thus, according to the present embodiment, the classes of tests are defined so as to correspond to the hardware configuration illustrated in FIG. 1. Class 1 is positioned at the highest hierarchical level.

Next, examples of various tables used in assigning a testing process are described below with reference to FIGS. 5 through 7.

FIG. 5 illustrates a grouping table as a practical example of the grouping information 101 illustrated in FIG. 4.

The grouping table indicates a group to which each CPU in the server apparatus 30 illustrated in FIG. 1 belongs in each class. In FIG. 5, each column corresponds to each CPU, and each row corresponds to each class.

In FIG. 5, in class 3 at the lowest hierarchical level, four CPUs belong to mutually different groups. That is, CPUs 00, 01, 10, and 11 respectively belong to the groups G30, G31, G32, and G33.

In FIG. 5, in class 2 at one level higher than class 3, the CPUs 00 and 01 belong to the group G20, and the CPUs 10 and 11 belong to the group G21. This grouping corresponds to the configuration in which the CPUs 00 and 01 are implemented in the SB 0, and the CPUs 10 and 11 are implemented in the SB 1. As exemplified in FIG. 5, each of the groups of class 2 includes one or more groups of class 3, which is immediately below class 2 in the hierarchy.

Also in FIG. 5, all of the four CPUs belong to the group G10 in class 1 at the highest hierarchical level. This grouping corresponds to the definition that the entire server apparatus 30 is one domain, and also corresponds to the configuration in which all of the four CPUs belong to the domain. As exemplified in FIG. 5, a group of class 1 includes one or more groups of class 2, which is immediately below class 1 in the hierarchy.

In the present embodiment, the SRAM 05 and 15 illustrated in FIG. 1 both store the grouping tables having the same contents. Accordingly, the CPUs 00 and 01 read the contents of the grouping table from the SRAM 05, and the CPUs 10 and 11 read the contents of the grouping table from the SRAM 15.

FIG. 6 illustrates a practical example of the priority table indicating the correspondence between the priority information 102 and the class information 103 illustrated in FIG. 4. In the method of the comparison example, the order of arranging a plurality of tests in a line is defined using the test order table illustrated in FIG. 2. In the present embodiment, the priority table illustrated in FIG. 6 is used instead.

Each row of the priority table corresponds to each test.

The leftmost column (except for the header column) of the priority table has the header of “class”, and indicates the class information 103.

For example, the respective rows of the tests A, C, and F store the values of “3”, “2”, and “1” indicating the classes of the respective tests. That is, the leftmost column indicates that the test A is a test of class 3 to be performed respectively by all CPUs, the test C is a test of class 2 to be performed by only one CPU among CPUs belonging to each SB, and the test F is a test of class 1 to be performed by only one CPU among CPUs belonging to a domain.

Each column other than the leftmost column (that is, other than the column of “class”) of the priority table corresponds to each individual test, and indicates the priority information 102. When the cell at the intersection of the row of the test X (where the test X is one of the tests A through M) and the column of the test Y (where the test Y is one of the tests A through M) stores the symbol “x”, it indicates that the test X is not allowed to be performed until the test Y is terminated, i.e., that the test Y has a higher priority than the test X.

On the other hand, when the cell at the intersection of the row of the test X and the column of the test Y is blank, it indicates that the test X is allowed to be performed even when the test Y is not terminated. Therefore, when both of the cell at the intersection of the row of the test X and the column of the test Y and the cell at the intersection of the row of the test Y and the column of the test X are blank, the test X is allowed to be performed prior to the test Y and the test Y is allowed to be performed prior to the test X.

Since the priority is not determined between the same tests, in FIG. 6, a diagonal line is indicated in the cell at the intersection of the row of the test X and the column of the test X.

In the present embodiment, both of the ROM 06 and 16 in FIG. 1 store the priority tables of the same contents. Accordingly, the CPUs 00 and 01 read the contents of the priority table from the ROM 06, and the CPUs 10 and 11 read the contents of the priority table from the ROM 16.

The class of each test in the priority table illustrated in FIG. 6 is the same as the class indicated in the test order table illustrated in FIG. 2 used in the method of the comparison example. However, the manners of defining the priorities are different between FIGS. 6 and 2.

In the test order table illustrated in FIG. 2, the execution order of the tests is limited to the specific order in the execution orders satisfying the restrictions relating to the priority. However, in FIG. 6, the execution order of the tests is flexible. For example, in FIG. 2, it is defined that the test C is invariably to be performed before the test D. However, FIG. 6 indicates that the test C is allowed to be performed prior to the test D and the test D is allowed to be performed prior to the test C.

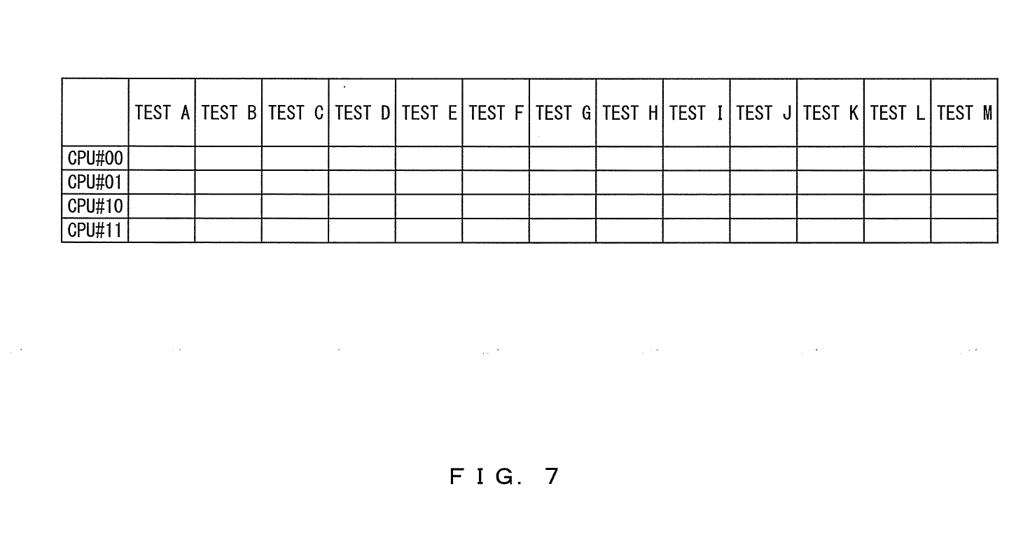

FIG. 7 illustrates a progress management table as a practical example of the progress information 104 illustrated in FIG. 4. The progress management table is dynamically rewritten. FIG. 7 illustrates the initial state.

In the present embodiment, since there are four CPUs in the server apparatus 30 in FIG. 1, the number of rows (except for the header row) of the progress management table is 4, and since the number of tests to be performed is 13 (which corresponds to the tests A through M), the number of columns (except for the header column) of the progress management table is 13.

In the progress management table, the cell at the intersection of the row of the CPU Z (where the CPU Z is any of the CPUs 00 through 11) and the column of the test Y (where the test Y is any of the tests A through M) indicates the progress related to the combination of the CPU Z and the test Y. The progress is classified into three states, that is, “untested”, “being tested”, and “tested”. The progress management table manages the progresses related to all combinations of all CPUs and all tests.

In the following description, the state of “tested” is expressed by the symbol “+”, the state of “being tested” is expressed by the symbol “−”, and the state of “untested” is expressed by a blank. Since FIG. 7 indicates an initial state, all cells are blank.

As described above, one progress management table is distributively stored in the SRAM 05 and 15 of FIG. 1 in the present embodiment. To be concrete, the rows of the CPUs 00 and 01 in the progress management table are stored in the SRAM 05 on the SB 0, and the rows of the CPUs 10 and 11 are stored in the SRAM 15 on the SB 1.

Even if the progress management table is thus distributively stored, each CPU is enabled to read and rewrite the data of all cells of the progress management table because the SBs 0 and 1 are connected through the XB 20.

The progress management table is dynamically rewritten and its contents are varied. A practical example of varying the contents is described later with reference to FIGS. 13A through 13H.

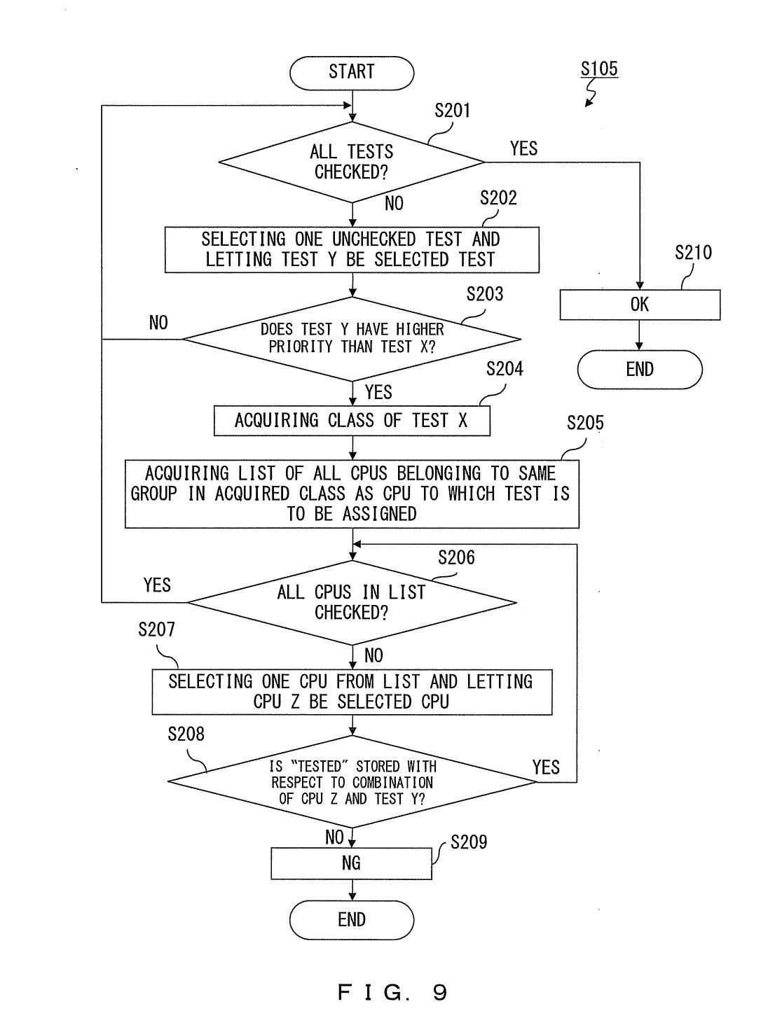

Next, the assigning method according to the present embodiment is described below with reference to FIGS. 8 through 11. In the present embodiment, the CPUs 00 through 11 illustrated in FIG. 1 concurrently and respectively perform the processes in FIGS. 8 through 11. FIG. 8 is a flowchart of the assigning method, and FIGS. 9 through 11 are flowcharts of the details of the steps illustrated in FIG. 8. An example of the case in which the CPU 00 performs the above-mentioned processes is described below for convenience.

The tests A through M according to the present embodiment are the testing processes included in the POSTs. Therefore, when the server apparatus 30 is powered on, each of the CPUs 00 through 11 starts the process illustrated in FIG. 8 in order to perform the POSTs.

In step S101 illustrated in FIG. 8, the CPU 00 acquires the lock to read and write the progress management table.

As described above, one progress management table is readable and writable from any CPU. Therefore, according to the present embodiment, exclusive control is performed to prevent the CPU 00 from conflicting with other CPU 01, 10, or 11 in updating the progress management table. For the exclusive control, the lock is acquired in step S101.

A practical method of realizing the lock may be any method used in performing exclusive control in a multiprocessor system.

In step S101, the CPU 00 attempts to acquire the lock. If the CPU 00 succeeds in acquiring the lock, then control is passed to step S102. If CPU 00 fails in acquiring the lock, then, the CPU 00 waits (e.g., waits for a predetermined time), and attempts again to acquire the lock. Control is not passed forward from step S101 until the lock is successfully acquired.

Next, in step S102, the CPU 00 sequentially searches the row of itself (that is, the row of the CPU 00) in the progress management table from the leftmost column for an untested item. If an untested item is detected, or if no untested item is detected after searching all columns of the progress management table, then control is passed to step S103.

In step S103, the CPU 00 determines whether or not an untested item has been detected in step S102. If there is no untested item, it means that there is no remaining test to be performed by the CPU 00. Accordingly, the CPU 00 terminates the process in FIG. 8 in this case.

On the other hand, if an untested item is detected in step S102, control is passed from step S103 to step S104.

In step S104, the CPU 00 selects the untested item detected in step S102. The selected test is referred to as a “test X” in the following description. In the present embodiment, the test X is any of the tests A through M.

Then, in step S105, the CPU 00 refers to the progress management table and checks whether or not all tests to be performed prior to the test X have been terminated (i.e., have been tested). The details of the check in step S105 are described later with reference to FIG. 9. The outline is given as follows.

There is one or more rows of the progress management table to be checked in step S105 depending on the class of the test X defined in the priority table.

When the test X is a test of class 1, that is, when only one CPU among the CPUs that belong to a domain is to perform the test X, the rows of all CPUs are checked in step S105.

If the test X is a test of class 2, that is, if only one CPU among the CPUs that belong to one SB is to perform the test X, then the rows of all CPUs in the same SB as the CPU in question are checked. For example, when the CPU 00 performs the process in FIG. 8, the rows of all CPUs in the SB 0 in which the CPU 00 is implemented, that is, the rows of the CPUs 00 and 01 are checked.

If the test X is a test of class 3, that is, if all CPUs are respectively to perform the test X, only the row of the CPU in question is checked. For example, if the CPU 00 performs the process in FIG. 8, then only the row of the CPU 00 is checked.

In one or more rows to be checked depending on the class of the test X, if all tests to be performed prior to the test X have been terminated, then control is passed to step S106. Otherwise, control is passed to step S109.

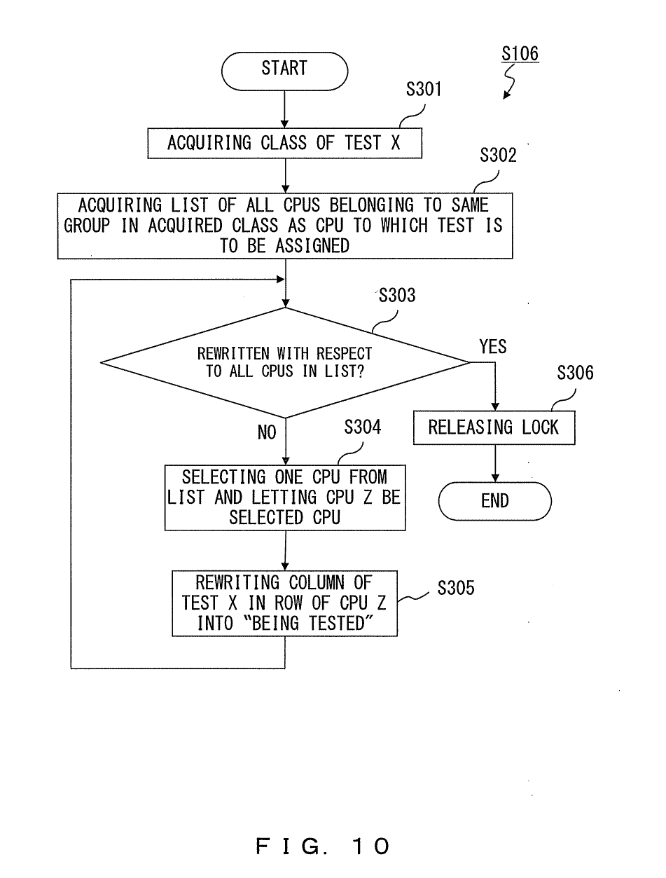

In step S106, the CPU 00 selects the test X as a test to be next performed, makes the progress management table reflect the selection, and releases the lock acquired in step S101. The details of step S106 are described later with reference to FIG. 10. The outline is given as follows.

The cell(s) in the progress management table to be rewritten in step S106 is/are the cell(s) of one or more rows in the column of the test X. Cell(s) to be rewritten in the column of the test X depend(s) on, as in step S105, the class of the test X.

That is, when the test X is a test of class 1, the CPU 00 rewrites the cells in the rows of all CPUs in the column of the test X into the symbol “−” indicating “being tested”.

When the test X is a test of class 2, the CPU 00 rewrites the cells in the rows of all CPUs in the same SB as the CPU in question (i.e., as the CPU 00 itself in this example) in the column of the test X into the symbol “−” indicating “being tested”. If the test X is a test of class 3, the CPU 00 rewrites only the cell in the row of the CPU in question (i.e., in the row of the CPU 00 itself in this example) in the column of the test X into the symbol “−” indicating “being tested”.

Next, in step S107, the CPU 00 performs the test X, and control is passed to step S108 after the completion of the test X.

In step S108, the CPU 00 writes, on the progress management table, the symbol “+” indicating “tested” in each cell in which the symbol “−” indicating “being tested” is written in step S106. Then, control is returned to step S101.

On the other hand, when control is passed from step 5105 to step S109, the CPU 00 searches the row of the CPU 00 itself in the progress management table for an untested item. The CPU 00 sequentially searches cells in this row, starting from the column next to the column of the test X detected in the search in step S102. If an untested item is detected or if no untested item is detected after searching the columns up to the rightmost column of the progress management table, then control is passed to step S110.

In step S110, the CPU 00 determines whether or not an untested item has been detected in step S109.

If an untested item is detected in step S109, control is returned to step S104. Then, in step S104, the CPU 00 selects the test detected in step S109 as a new “test x”; and the CPU 00 performs again the processes in and after step S105.

If no untested item is detected in step S109, control is passed to step S111. In this case, since at least the test X detected in step S102 is untested, there is still a test to be performed. However, there is no test that is allowed to be immediately performed. Therefore, the CPU 00, at this time, releases the lock acquired in step S101, and waits (i.e., stands by) for an appropriate time. After the wait, the control is returned to step S101.

The waiting time (i.e., the standby time) in step S111 is in accordance with a predetermined policy. For example, the waiting time (i.e., the standby time) may be a time fixedly determined in advance, a time of a random length, a time determined depending on the state of the progress management table, etc.

The processes in steps S101 through S111 are repeatedly performed in the above-mentioned way until it is determined in step S103 that an untested item does not remain any more.

Next, the processes in step S105 illustrated in FIG. 8 are described below in detail with reference to the flowchart in FIG. 9. The process illustrated in FIG. 9 is performed after the “untested” test X is selected in step S104 in FIG. 8. As with the description with reference to FIG. 8, an example of the case in which the CPU 00 performs the process in FIG. 9 is described below for convenience.

In step S201 in FIG. 9, the CPU 00 determines whether or not a check by the processes in and after step S202 has been performed on all tests. If all tests have been checked, control is passed to step S210. Otherwise, control is passed to step S202.

In the present embodiment, the above-mentioned “all tests” means 13 tests A through M. The CPU 00 is able to recognize that there are 13 tests A through M by referring to the priority table or the progress management table.

In step S202, the CPU 00 selects one unchecked test. The selected test is referred to as a “test Y” in the following description. In the present embodiment, the test Y is any of the tests A through M.

Then, in step S203, the CPU 00 refers to the priority table, and determines whether or not the test Y has a higher priority than the test X. In the priority table in FIG. 6, if the cell at the intersection of the row of the test X and the column of the test Y stores the symbol “x”, it indicates that the test Y has a higher priority than the test X. Accordingly, the control is passed to step S204 in this case.

If the cell at the intersection of the row of the test X and the column of the test Y is blank in the priority table in FIG. 6, it indicates that it is not necessary that the test Y is performed prior to the test X. Therefore, the test Y turns to be a “checked” test, and control is returned to step S201. Similarly, when the test Y is equal to the test X (i.e., Y=X), control is returned to step S201.

In step S204, the CPU 00 acquires the class of the test X with reference to the priority table. Then, in step S205, the CPU 00 refers to the grouping table to acquire a list of all CPUs belonging to the same group in the class acquired in step S204 as the CPU to which the test is to be assigned (that is, as the CPU 00 itself).

An exemplary description of step S205 is provided herein with reference to an example of the grouping table in FIG. 5. The CPU 00 refers to the row of class 1 of the grouping table if the class acquired in step S204 is class 1. In this case, the CPUs that belong to the same group as the CPU 00 are four CPUs (including the CPU 00 itself), that is, the CPUs 00, 01, 10, and 11. Therefore, in step S205, the CPU 00 acquires a list including the four CPUs as elements.

Similarly, when the class acquired in step S204 is class 2, the CPU 00 refers to the row of class 2 of the grouping table. In this case, the CPUs that belong to the same group as the CPU 00 are two CPUs (including the CPU 00 itself), that is, the CPUs 00 and 01. Therefore, in step S205, the CPU 00 acquires a list including the two CPUs as elements.

Similarly, when the class acquired in step S204 is class 3, the CPU 00 refers to the row of class 3 of the grouping table. In this case, the CPU that belongs to the same group as the CPU 00 is only the CPU 00 itself. Therefore, in step S205, the CPU 00 acquires a list having only the CPU 00 as an element.

Next, control is passed to step S206, and the CPU 00 determines whether or not all CPUs in the list acquired in step S205 have been checked insteps S207 and 5208. If all CPUs have been checked, the test Y turns to be “checked”, and control is returned to step S201. Otherwise, control is passed to step S207.

In step S207, the CPU 00 selects one of unchecked CPUs from the list acquired in step S205. The selected CPU is referred to as a “CPU Z” in the following description.

Then, in step S208, the CPU 00 refers to the cell at the intersection of the row of the CPU Z and the column of the test Y in the progress management table. If the cell stores the symbol “+” indicating “tested”, then control is returned to step S206. Otherwise, control is passed to step S209.

The process in step S209 is performed when the condition that all tests to be performed prior to the test X have been performed is not satisfied. In this case, the execution of the test X is not permitted. Accordingly, the CPU 00 obtains a result of “NG” in step S209, terminates the process in FIG. 9, and returns control to the process in FIG. 8. Afterwards, since the result acquired in step S209 is “NG”, control in FIG. 8 is passed from step S105 to step S109.

On the other hand, when control is passed from 5201 to step S210, the condition that all tests to be performed prior to the test X have been terminated is satisfied. Therefore, in step S210, the CPU 00 obtains a result of “OK”, terminates the process in FIG. 9, and returns control to the process in FIG. 8. Afterwards, since the result acquired in step S210 is “OK”, control in FIG. 8 is passed from step S105 to step S106.

Next, the details of step S106 in FIG. 8 are described below with reference to the flowchart in FIG. 10. The process in FIG. 10 is performed when it is ascertained in step S105 in FIG. 8 that all tests to be performed prior to the unperformed (i.e., “untested”) test X have been performed and terminated (i.e., “tested”). As with the description with reference to FIG. 8, the case in which the CPU 00 performs the process in FIG. 10 is described as an example for convenience.

In step S301, the CPU 00 refers to the priority table and acquires the class of the test X.

Next, in step S302, the CPU 00 refers to the grouping table to acquire a list of all CPUs belonging to the same group in the class acquired in step S301 as the CPU to which the test is to be assigned (that is, as the CPU 00 itself). Since step S302 is similar to step S205 in FIG. 9, the detailed description is omitted here.

Then in step S303, the CPU 00 determines whether or not the progress management table has been rewritten in steps S304 and 5305 on all CPUs in the list acquired in step S302. If the progress management table has been rewritten on all CPUs in the list, then control is passed to step S306. Otherwise, control is passed to step S304.

In step S304, the CPU 00 selects, from the list acquired in step S302, one CPU with respect to which the progress management table has not yet been rewritten. The selected CPU is referred to as a “CPU Z” in the following description.

Next, in step S305, the CPU 00 rewrites the cell at the intersection of the row of the CPU Z and the column of the test X in the progress management table into “−” indicating “being tested”. Then, control is returned to step S303.

When control is passed from step S303 to step S306, the CPU 00 releases the lock acquired in step S101 in FIG. 8 before starting the process in FIG. 10, and terminates the process in FIG. 10.

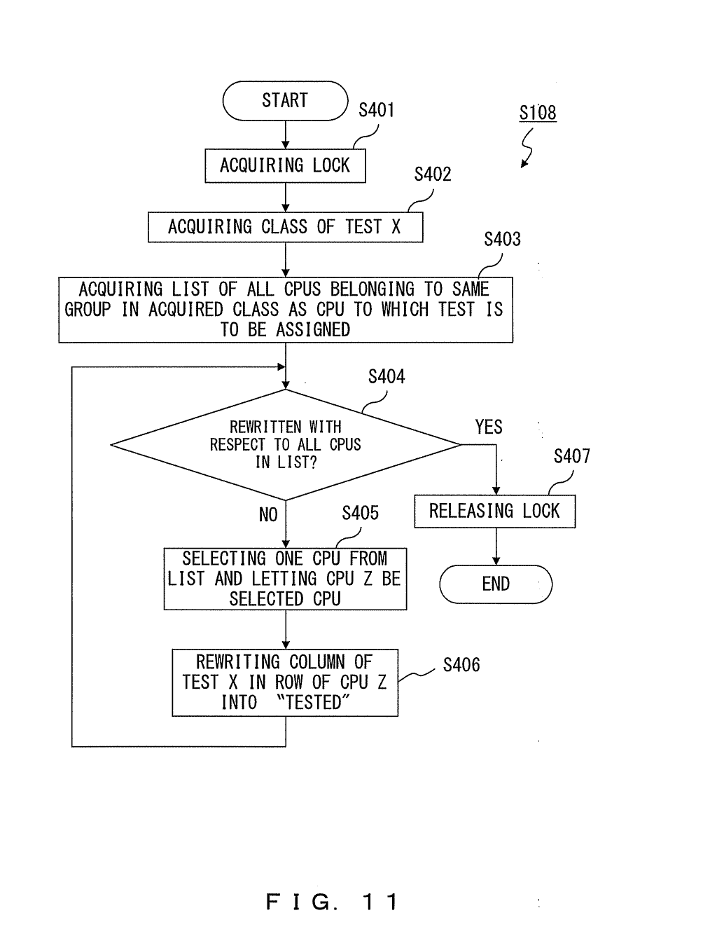

Next, the details in step S108 in FIG. 8 is described below with reference to the flowchart in FIG. 11. The process in FIG. 11 is performed immediately after the test X is performed and terminated in step S107 in FIG. 8. As with the description with reference to FIG. 8, the case in which the CPU 00 performs the process in FIG. 11 is described as an example.

In step S401 in FIG. 11, the CPU 00 acquires the lock for rewriting the progress management table. Since the process is similar to the process in step S101 in FIG. 8, the detailed description is omitted here. If the lock is successfully acquired, control is passed to step S402.

In step S402, the CPU 00 acquires the class of the test X with reference to the priority table.

Next, in step S403, the CPU 00 refers to the grouping table to acquire a list of all CPUs belonging to the same group in the class acquired in step S402 as the CPU to which the test is to be assigned (that is, as the CPU 00 itself). Since step S403 is similar to step S205 in FIG. 9 and step S302 in FIG. 10, the detailed description is omitted here.

Then, in step S404, the CPU 00 determines on all CPUs in the list acquired in step S403 whether or not the progress management table has been rewritten in steps S405 and 5406. If the progress management table has been rewritten on all CPUs in the list, control is passed to step S407. Otherwise, control is passed to step S405.

In step S405, the CPU 00 selects, from the list acquired in step S403, one CPU with respect to which the progress management table has not yet been rewritten. The selected CPU is referred to as a “CPU Z” in the following description.

Next, in step S406, the CPU 00 rewrites the cell at the intersection of the row of the CPU Z and the column of the test X in the progress management table into “+” indicating “tested”. Then, control is returned to step S404.

When control is passed from step S404 to step S407, the CPU 00 releases the lock acquired in step S401, and terminates the process in FIG. 11.

Next, a practical example of an assigning process is described below with reference to the timing chart in FIG. 12 and the transition of the data of the progress management table in FIGS. 13A through 13H. In this practical example, the information in FIGS. 5 and 6 is used.

In FIG. 12, the down arrows indicate the lapse of time. FIG. 12 illustrates an exemplary case in which the CPUs 00, 01, 10, and 11 concurrently and respectively perform the process of FIG. 8. The numbers 1 through 8 given with the horizontal dotted lines in FIG. 12 indicate the time points of the respective dotted lines.

When the server apparatus 30 is powered on, the four CPUs start their respective processes in FIG. 8. At this time point, the progress management table is in the initial state illustrated in FIG. 7.

In the example in FIG. 12, for example, the CPU 00 first acquires the lock in step S101, and finds the untested test A in step S102. Since there is no test having a higher priority than the test A, control is passed to step S106. Since the test A is a test of class 3, the CPU 00 rewrites the cell at the intersection of the row of the CPU 00 and the column of the test A in the progress management table into “−”, releases the lock, and performs the test A.

Similarly, each CPU acquires the lock in the order of, for example, the CPU 01, the CPU 10, and the CPU 11, and each of them performs the test A.

Afterwards, for example, assume that the CPU 00 first terminates the test A. Upon the termination, in step S108, the CPU 00 rewrites the cell at the intersection of the row of the CPU 00 and the column of the test A in the progress management table into “+”, and control is returned to step S101. The other three CPUs follow the same processes.

Following the test A, the test B of class 3 is similarly performed by each CPU. At the time point 1 in FIG. 12, all CPUs have already terminated the tests A and B.

The operation of the CPU 00 at the time point 1 is described below. The CPU 00 acquires the lock in step S101, and finds an untested test C in step S102. Note that the test C is a test of class 2. Also note that, in class 2, the CPUs 00 and 01 belong to the same group G20 to which the CPU 00 belongs, and that the tests having higher priorities than the test C are tests A and B.

At the time point 1, since the CPUs 00 and 01 have already terminated the tests A and B, control is passed to step S106. In step S106, the CPU 00 rewrites the cells at the intersections of the rows of the CPUs 00 and 01 and the column of the test C in the progress management table into “−”, and releases the lock. Then, the CPU 00 performs the test C.

When the lock is released, the CPU 01 that has been waiting in step S101 next acquires the lock. Then, the CPU 01 searches for an untested item in step S102.

The CPU 01 has already terminated the tests A and B at the time point 1. On the other hand, the CPU 01 has not yet performed the test C. However, the test C is not found by the CPU 01 as the untested item.

The reason is that the test C is a test of class 2, and that the CPU 00 belonging to the same group in class 2 as the CPU 01 is performing the test C. Therefore, the item found by the CPU 01 in step S102 is not the test C but the test D.

Note that the test D is a test of class 2. Also note that, in class 2, the CPUs 00 and 01 belong to the same group G20 to which the CPU 01 belongs, and that the tests having higher priorities than the test D are tests A and B.

At the time point 1, since the CPUs 00 and 01 have already terminated the tests A and B, control is passed to step S106. In step S106, the CPU 01 rewrites the cells at the intersections of the rows of the CPUs 00 and 01 and the column of the test D in the progress management table into “−”, and releases the lock. Then, the CPU 01 performs the test D.

Similarly, the CPU 10 performs the test C, and the CPU 11 performs the test D. As a result, the progress management table enters the state illustrated in FIG. 13A.

As briefly described above relating to the progress information 104 in FIG. 4, the progress on the combination of the CPU Z and the test Y in the progress management table does not necessarily indicate the progress of the execution of the test Y by the CPU Z itself. This will be described below with an example of the row of the CPU 00 in FIG. 13A.

As described above, at the time point where the progress management table is in the state illustrated in FIG. 13A, the CPU 00 is performing the test C, but it is not performing the test D. Nevertheless, in the row of the CPU 00 in FIG. 13A, the two cells respectively in the columns of the tests C and D store “−”.

The reason is as follows. The test D is a test of class 2. Accordingly, once one of the two CPUs 00 and 01 on the SB 0 performs the test D, the other is no longer allowed to perform the test D.

A blank cell at the intersection of the row of the CPU 00 and the column of the test D in the progress management table does not simply mean that the test D has not yet been performed by the CPU 00, but rather means that the test D may potentially be assigned to the CPU 00 in future.

Therefore, to make the progress management table reflect the fact that the possibility that the test D is assigned to the CPU 00 is eliminated by the CPU 01 starting to perform the test D, the process in FIG. 10 is performed. As a result, the cell at the intersection of the row of the CPU 00 and the column of the test D is rewritten into “−”.

Similarly, when the test Y is a test of class 1, the cell at the intersection of the row of the CPU Z and the column of the test Y is rewritten into “−” and then into “+” even if the CPU Z itself does not perform the test Y.

Back to the description with reference to FIG. 12, the time taken to perform a test depends on the type of test, and also depends on the state of the resources to be tested. Therefore, as in the example in FIG. 12, the test C may be performed in a shorter time by the CPU 00 than by the CPU 10.

As illustrated in FIG. 12, at the time point 2, the CPU 00 has terminated the test C, the CPU 01 is performing the test D, the CPU 10 is performing the test C, and the CPU 11 has terminated the test D. Therefore, the CPU 00 performs the process in step S108 at the time point 2, and rewrites the cells at the intersections of the rows of the CPUs 00 and 01 and the column of the test C in the progress management table into “+”. Then, control is returned to step S101.

Similarly, the CPU 11 performs the process in step S108 at the time point 2, and rewrites the cells at the intersections of the rows of the CPUs 10 and 11 and the column of the test D in the progress management table into “+”. Then, control is returned to step S101.

When the CPU 00 acquires the lock back in step S101, it searches for an untested item in step S102, and then, it finds the test E. Note that the test E is a test of class 2. Also note that, in class 2, the CPUs 00 and 01 belong to the same group G20 to which the CPU 00 belongs, and that the tests having higher priorities than the test E are tests A and B.

At the time point 2, since the CPUs 00 and 01 have already terminated the tests A and B, control is passed to step S106. In step S106, the CPU 00 rewrites the cells at the intersections of the rows of the CPUs 00 and 01 and the column of the test E in the progress management table into “−”, and releases the lock. Then, the CPU 00 performs the test E.

When the lock is released, the CPU 11 that has been waiting in step S101 next acquires the lock, and performs the test E as with the CPU 00. As described above, the progress management table enters the state illustrated in FIG. 13B.

Then, at the time point 3, the CPU 01 terminates the test D, and rewrites the cells at the intersections of the rows of the CPUs 00 and 01 and the column of the test D in the progress management table into “+” in step S108. Thus, the progress management table enters the state illustrated in FIG. 13C.

Then, the CPU 01 acquires the lock in step S101, searches for an untested item in step S102, and finds the test F. Note that the test F is a test of class 1, and that the tests having higher priorities than the test F are tests A, B, and C. Therefore, in step S105, the cells at the intersections of all of the four rows and the columns of the tests A, B, and C in the progress management table are checked.

As illustrated in FIG. 12, at the time point 3, the CPU 10 is performing the test C. Therefore, as illustrated in FIG. 13C, the cells at the intersections of the rows of the CPUs 10 and 11 and the column of the test C in the progress management table store “−”. Accordingly, control is passed from step S105 to step S109.

Afterwards, the loop of returning to step S104 through steps S109 and S110 is repeatedly performed, and thereby the CPU 01 performs the priority checking process in step S105 (that is, in FIG. 9) for each of the untested tests G through M. However, since all of the tests G through M have lower priorities than the test C, control is passed to step S111 after all. In step S111, the CPU 01 releases the lock and waits. After the wait, the CPU 01 returns control to step S101.

A little after the time point 3, the CPU 10 terminates the test C, rewrites the cells at the intersections of the rows of the CPUs 10 and 11 and the column of the test C in the progress management table into “+” in step S108, and returns control to step S101.

When the CPU 10 terminates the test C and rewrites the progress management table in step S108, the CPU 01 that has been attempting to acquire the lock in step S101 succeeds in acquiring the lock. Then, in step S102, the CPU 01 searches for an untested item, and the test F is found.

Note that the test F is a test of class 1, and that the tests having higher priorities than the test F are tests A, B, and C. Also note that, at this time point, the cells at the intersections of all of the four rows and the columns of the tests A, B, and C in the progress management table have already been rewritten into “+”.

Therefore, control is passed from step S105 to step S106. Then, in step S106, the CPU 01 rewrites the cells at the intersections of all of the four rows and the column of the test F in the progress management table into “−”, and releases the lock. Then, the CPU 01 performs the test F in step S107.

On the other hand, when the lock is released, the CPU 10 that has terminated the test C acquires the lock in step S101. The CPU 10 searches for an untested item in step S102, and finds the test G.

Note that the test G is a test of class 1, and that the tests having higher priorities than the test G are tests A, B, C, D, and E. On the other hand, at this time point, each of the CPUs 00 and 11 is performing the test E, and therefore all of the four cells of the column of the test E of the progress management table store “−”. Therefore, control is passed from step S105 to step S109.

Afterwards, the loop back to step S104 through steps S109 and S110 is repeatedly performed, and thereby the CPU 10 performs the priority checking process in step S105 (that is, in FIG. 9) for each of the untested tests H through M. However, since all of the tests H through M have lower priorities than the test E, control is passed to step S111 after all. In step S111, the CPU 10 releases the lock and waits. After the wait, control is returned to step S101.

As illustrated in FIG. 12, after the termination of the test C by the CPU 10, the CPU 00 terminates the test E. Then, in step S108, CPU 00 rewrites the cells at the intersections of the rows of the CPUs 00 and 01 and the column of the test E in the progress management table into “+”. After that, back in step S101, the CPU 00 acquires the lock.

On the other hand, the CPU 11 is still performing the test E at this time point. Therefore, for the same reason as the CPU 10 above, the CPU 00 also waits in step S111.

Afterwards, the CPU 11 terminates the test E. Then, the CPU 11 rewrites the cells at the intersections of the rows of the CPUs 10 and 11 and the column of the test E in the progress management table into “+” in step S108, and returns control to step S101. At the time point 4, the progress management table has been thus rewritten.

At the time point 4, the CPUs 00, 10, and 11 are waiting or attempting to acquire the lock. In the example illustrated in FIG. 12, it is assumed that the CPU 00 first succeeds in acquiring the lock. The CPU 00 acquires the lock in step S101, and finds the test G of class 1 in step S102. Then, control is passed to step S106 because in all columns of the tests A, B, C, D, and E having higher priorities than the test G, all of the cells in all of the four rows of the progress management table store “+”.

In step S106, the CPU 00 writes “−” in the cells at the intersections of all of the four rows and the column of the test G in the progress management table, and releases the lock. Then, the CPU 00 performs the test G in step S107.

When the lock is released, the CPU 10 next acquires the lock in step S101, and finds the test H in step S102. Note that the test H is a test of class 3, and that, at the time point 4, “+” is stored, in the progress management table, in each of the cells at the intersections of the row of the CPU 10 and the columns of the tests A, B, C, D, and E having higher priorities than the test H.

Therefore, control is passed from step S105 to step S106. In step S106, the CPU 10 rewrites the cell at the intersection of the row of the CPU 10 and the column of the test H in the progress management table into “−”, and releases the lock. Then, the CPU 01 performs the test H in step S107.

When the lock is released, the CPU 11 next acquires the lock in step S101. Then, the CPU 11 performs the test H as with the CPU 10. At this time point, the progress management table enters the state illustrated in FIG. 13D.

In the example in FIG. 12, the test H by the CPU 10 and the test H by the CPU 11 terminate earlier than the test G by the CPU 00 and the test F by the CPU 01. Upon the termination, the CPU 10 rewrites the cell at the intersection of the row of the CPU 10 and the column of the test H in the progress management table into “+” in step S108, and then returns control to step S101. Similarly, the CPU 11 rewrites the cell at the intersection of the row of the CPU 11 and the column of the test H in the progress management table into “+” in step S108, and then returns control to step S101.

Then, the CPU 10 acquires the lock in step S101, and finds the test I in step S102. Note that the test I is a test of class 3, and that, in the progress management table, “+” is stored in each of the cells at the intersections of the row of the CPU 10 and the columns of the tests A, B, C, D, and E having higher priorities than the test I.

Therefore, control is passed from step S105 to step S106. In step S106, the CPU 10 rewrites the cell at the intersection of the row of the CPU 10 and the column of the test I in the progress management table into “−”, and releases the lock. Then, the CPU 10 performs the test I in step S107.

When the lock is released, the CPU 11 next acquires the lock in step S101, and performs the test I as with the CPU 10.

On the other hand, at the time point 5, the CPU 00 terminates the test G, and rewrites the cells at the intersections of all of the four rows and the column of the test Gin the progress management table into “+” in step S108. Then, the CPU 00 acquires the lock back in step S101, and finds the test H in step S102.

Note that the test H is a test of class 3. Also note that, at the time point 5, “+” is written, in the progress management table, to the cells at the intersections of the row of the CPU 00 and the columns of the tests A, B, C, D, and E having higher priorities than the test H.

Therefore, control is passed from step S105 to step S106. In step S106, the CPU 00 rewrites the cell at intersection of the row of the CPU 00 and the column of the test H in the progress management table into “−”, and releases the lock. Then, the CPU 00 performs the test H in step S107. Thus, the progress management table enters the state in FIG. 13E.

Afterwards, the CPUs 10 and 11 terminate the respective tests I. The CPU 10 rewrites the cell at the intersection of the row of the CPU 10 and the column of the test I in the progress management table into “+” in step S108, and returns control to step S101. Similarly, the CPU 11 rewrites the cell at the intersection of the row of the CPU 11 and the column of the test I in the progress management table into “+” in step S108, and returns control to step S101.

Then, the CPU 10 acquires the lock in step S101, and finds the test J in step S102. However, in the tests having higher priorities than the test J, the test F of class 1 is still being performed by the CPU 01.

Therefore, control is passed from step S105 to step S109. Since all other tests K through M that are “untested” for the CPU 10 also have lower priorities than the test F, the CPU 10 waits in step S111, and returns control to step S101 after the wait.

Similarly, the CPU 11 that has terminated the test I waits in step S111, and then returns control to step S101.

Afterwards, the CPU 00 terminates the test H, rewrites the cell at the intersection of the row of the CPU 00 and the column of the test H in the progress management table into “+” in step S108, and then returns control to step S101. In addition, the CPU 01 terminates the test F, rewrites the cells at the intersections of all of the four rows and the column of the test F in the progress management table into “+” in step S108, and then returns control to step S101.

Thus, in the time point 6, all of the four CPUs attempt to acquire the lock in step S101. For example, assume that the CPU 00 first succeeds in acquiring the lock. The CPU 00 then finds the test I in step S102.

Note that the test I is a test of class 3, and that, at the time point 6, in the progress management table, “+” is written into each of the cells at the intersections of the row of the CPU 00 and the columns of all tests having higher priorities than the test I. Therefore, in step S106, the CPU 00 rewrites the cell at the intersection of the row of the CPU 00 and the column of the test I in the progress management table into “−”, and releases the lock. Then, the CPU 00 performs the test I in step S107.

If the lock is released, the CPU 01 then acquires the lock, and finds the test H in step S102. Note that the test H is a test of class 3, and that the cells at the intersections of the row of the CPU 01 and the columns of all tests having higher priorities than the test H store “+” at the time point 6 in the progress management table.

Therefore, in step S106, the CPU 01 rewrites the cell at the intersection of the row of the CPU 01 and the column of the test H in the progress management table into “−”, and releases the lock. Then, the CPU 01 performs the test H in step S107.

When the lock is released, the CPU 10 then acquires the lock, and finds the test J in step S102. Note that the test J is a test of class 3, and that the cells at the intersections of the row of the CPU 10 and the columns of all tests having higher priorities than the test J store “+” in the progress management table at the time point 6.

Therefore, in step S106, the CPU 10 rewrites the cell at the intersection of the row of the CPU 10 and the column of the test J in the progress management table into “−”, and releases the lock. Then, the CPU 10 performs the test J in step S107.

When the lock is released, the CPU 11 then acquires the lock, and performs the test J as with the CPU 10. As described above, the progress management table enters the state illustrated in FIG. 13F.

Then, the CPU 00 terminates the test I, rewrites the cell at the intersection of the row of the CPU 00 and the column of the test I in the progress management table into “+” in step S108, and returns control to step S101. In addition, the CPU 01 terminates the test H, rewrites the cell at the intersection of the row of the CPU 01 and the column of the test H in the progress management table into “+” in step S108, and returns control to step S101.

Furthermore, the CPU 10 terminates the test J, rewrites the cell at the intersection of the row of the CPU 10 and the column of the test J in the progress management table into “+” in step S108, and returns control to step S101. Similarly, the CPU 11 terminates the test J, rewrites the cell at the intersection of the row of the CPU 11 and the column of the test J in the progress management table into “+” in step S108, and returns control to step S101. The time point 7 indicates a time point when the above-described processes have just been done.

At the time point 7, for example, the CPU 00 first acquires the lock, finds the test J in step S102, and passes control from step S105 to step S106. Then, the CPU 00 rewrites the cell at the intersection of the row of the CPU 00 and the column of the test J in the progress management table into “−”, and releases the lock. Then, the CPU 00 performs the test J in step S107.

If the lock is released, the CPU 01 then acquires the lock, finds the test I in step S102, and passes control from step S105 to step S106. Then, the CPU 01 rewrites the cell at the intersection of the row of the CPU 01 and the column of the test I in the progress management table into “−”, and releases the lock. Then, the CPU 01 performs the test I in step S107.

If the lock is released, the CPU 10 next acquires the lock, and finds the test K in step S102. Note that the test K is a test of class 1, and that “+” is stored at the time point 7 in the cells at the intersections of all of the four rows and the columns of the tests A through H, which have higher priorities than the test K, in the progress management table.

Therefore, control is passed from step S105 to step S106. In step S106, the CPU 10 rewrites the cells at the intersections of all of the four rows and the columns of the test K in the progress management table into “−”, and releases the lock. Then, the CPU 10 performs the test K in step S107.

If the lock is released, the CPU 11 then acquires the lock, and finds the test L in step S102. Note that the test L is a test of class 2, and that, in class 2, the CPUs 10 and 11 implemented in the same SB 1 belong to the same group G21 to which the CPU 11 belongs. Also note that, in the progress management table, “+” is stored at the time point 7 in the cells at the intersections of the two rows of the CPUs 10 and 11 and the columns of all of the tests having higher priorities than the test L.

Therefore, control is passed from step S105 to step S106. In step S106, the CPU 11 rewrites the cells at the intersections of the two rows of the CPUs 10 and 11 and the column of the test L in the progress management table into “−”, and releases the lock. Then, the CPU 11 performs the test L in step S107. Thus, the progress management table enters the state illustrated in FIG. 13G.

Then, each CPU at the time point 8 is in the following state.

The CPU 00 has terminated the test J, has rewritten the cell at the intersection of the row of the CPU 00 and the column of the test J in the progress management table into “+” in step S108, and has returned control to S101. The CPU 01 has terminated the test I, has rewritten the cell at the intersection of the row of the CPU 01 and the column of the test I in the progress management table into “+” in step S108, and has returned control to step S101.

The CPU 10 is performing the test K. The CPU 11 has terminated the test L, has rewritten the cells at the intersections of the rows of the CPUs 10 and 11 and the column of the test L in the progress management table into “+” in step S108, and has returned control to step S101.

In the example in FIG. 12, assume that in the CPUs 00, 01, and 11 that are attempting to acquire the lock at the time point 8, the CPU 00 first succeeds in acquiring the lock. When the CPU 00 acquires the lock in step S101, it finds the test L in step S102.

Note that the test L is a test of class 2. Also note that, in the progress management table, the cells at the intersections of the rows of the CPUs 00 and 01 and the columns of all tests having higher priorities than the test L store “+” at the time point 8.

Therefore, control is passed from step S105 to step S106. Then, in step S106, the CPU 00 rewrites the cells at the intersections of the two rows of the CPUs 00 and 01 and the column of the test L in the progress management table into “−”, and releases the lock. Then, the CPU 00 performs the test L in step S107.

If the lock is released, the CPU 01 next acquires the lock in step S101, finds the test J in step S102, and passes control from step S105 to step S106. In step S106, the CPU 01 rewrites the cell at the intersection of the row of the CPU 01 and the column of the test J in the progress management table into “−”, and releases the lock. Then, the CPU 01 performs the test J in step S107.

If the lock is released, the CPU 11 then acquires the lock in step S101, and finds the test M in step S102. Note that the test M is a test of class 3. Also note that, in the progress management table, the cells at the intersections of the row of the CPU 11 and the columns of all tests having higher priorities than the test M store “+” at the time point 8. Therefore, control is passed from step S105 to step S106.

In step S106, the CPU 11 rewrites the cell at the intersection of the row of the CPU 11 and the column of the test M in the progress management table into “−”, and releases the lock. Then, the CPU 11 performs the test M in step S107. Thus, the progress management table enters the state in FIG. 13H.

Afterwards, the CPU 10 terminates the test K, rewrites the cells at the intersections of all rows and the column of the test K in the progress management table into “+” in step S108, and returns control to step S101. Then, the CPU 10 acquires the lock in step S101, finds the test M in step S102, and passes control from step S105 to step S106.

In step S106, the CPU 10 rewrites the cell at the intersection of the row of the CPU 10 and the column of the test M in the progress management table into “−”, and releases the lock. Then, the CPU 10 performs the test M in step S107.

Then, the CPU 11 terminates the test M, rewrites the cell at the intersection of the row of the CPU 11 and the column of the test Min the progress management table into “+” in step S108, returns control to step S101, and acquires the lock. The CPU 11 searches for an untested item in step S102, but there is no untested item any more. Therefore, in step S103, the CPU 11 determines that there is no untested item, and terminates the process in FIG. 8.

Meanwhile, the CPU 00 terminates the test L, and the CPU 01 terminates the test J. Then, the CPU 00 rewrites the cells at the intersections of the rows of the CPUs 00 and 01 and the column of the test L in the progress management table into “+” in step S108, and returns control to step S101. The CPU 01 rewrites the cell at the intersection of the row of the CPU 01 and the column of the test J in the progress management table into “+” in step S108, and returns control to step S101.

Then, the CPU 00 acquires the lock in step S101, finds the test M in step S102, passes control from step S105 to step S106, rewrites the cell at the intersection of the row of the CPU 00 and the column of the test M in the progress management table into “−”, and releases the lock. Then, the CPU 00 performs the test M in step S107. If the lock is released, the CPU 01 acquires the lock, and similarly performs the test M.

Afterwards, the CPUs 10, 00, and 01 sequentially terminate the test M, and respectively terminate the process in FIG. 8 as with the CPU 11.

Thus, the practical example illustrated in FIGS. 12 and 13A through 13H is described above. As illustrated in FIG. 12, in the present embodiment, each CPU concurrently (i.e., simultaneously) performs tests that the CPU assigns to itself. Therefore, when FIG. 3 illustrating the method of the comparison example is compared with FIG. 12 according to the present embodiment, it is clear that redundant (i.e., wasteful) waiting time is reduced in FIG. 12.

That is, in the method of the comparison example illustrated in FIG. 3, one CPU 00 performs all of the tests A through M, but in the example illustrated in FIG. 12, the tests D, F, and K are performed by other CPUs, that is, the CPUs 01, 10, or 11. As exemplified in FIG. 12, according to the present embodiment, a test is assigned depending on the situation. Therefore, redundant waiting time is reduced, and the total test time is shorter than in the method of the comparison example in FIG. 3.

As described above, in the present embodiment, the progress information 104 is rewritten by the assignment unit 109. Therefore, the progress information 104 dynamically varies. The assignment unit 109 assigns the testing process to the testing unit 111 according to the dynamically variable progress information 104. That is, according to the present embodiment, the testing process is dynamically assigned to the testing unit 111 depending on the situation. Accordingly, redundant waiting time is reduced, and the total test time is shortened.

The present invention is not limited to the above-mentioned embodiments, but may be modified. Described below are some of the examples.

In the above-mentioned embodiments, a test targeted at hardware resources provided for each SB (e.g., targeted at hardware resources such as a DIMM etc.) is described as an example of a test of class 2, and it is assumed that one CPU on each SB performs a test of class 2 targeted at the hardware resources of the SB itself.

However, the hardware configuration of a device depends on an embodiment. Depending on the hardware configuration, there is a case in which it is feasible for a CPU to perform a certain test even though an SB in which the hardware resources to be tested are implemented is different from another SB in which the CPU that performs the certain test is implemented.

In this case, a test targeted at the hardware resources provided for each SB may be defined as a plurality of tests of class 1, not as one test of class 2. Such definition further improves the concurrency of tests and shortens the total test time.

For example, a test of class 2 referred to as a “memory test” targeted at a DIMM provided for each SB may be replaced with two tests of class 1 defined as a “memory test of the SB 0” targeted at the DIMM 02 provided for the SB 0 and a “memory test of SB 1” targeted at the DIMM 12 provided for the SB 1.

Defining the above-mentioned tests makes a memory test on the SB 0 executable even in the case where, for example, the SB 0 has only one CPU 00 and the CPU 00 is currently performing another test. The above-mentioned definition enables a CPU in the idle state on the SB other than the SB 0 to perform the memory test on the SB 0. As a result, the waiting time is reduced, and the total test time is shortened.

In addition, the above-mentioned definition defining the test targeted at the hardware resources provided for each SB as a test of class 1 makes an embodiment applicable to the apparatus including an SB in which no CPU is implemented.

In the above-mentioned embodiment, three classes, that is, classes 1 through 3, are defined. However, the number of classes may be an arbitrary number equal to or more than two. The number of classes may be appropriately determined depending on the hardware configuration, the types of tests, etc.

For example, for a computer having only one SB, it may be appropriate to define only two classes, that is, a class corresponding to each CPU, and a class corresponding to the entire computer (that is, corresponding to the entire SB).

In the above-mentioned embodiment, class 3 at the lowest hierarchical level corresponds to each CPU. However, in the POSTs performed within an apparatus in which a multi-core processor having a plurality of cores is implemented, there is also a test to be performed on each core.

Therefore, for example, for a server apparatus including two or more SBs in each of which a plurality of multi-core processors are implemented, four classes may be defined. The four classes, from the bottom of the hierarchy, respectively correspond to one core, one multi-core processor (that is, one CPU), one SB, and the entire server apparatus (that is, one domain).

Otherwise, when a plurality of computers are operated in a cluster, the class at the highest hierarchical level may be defined as a class corresponding to the entire cluster.

In the above-mentioned embodiment, each CPU concurrently and respectively performs the process in FIG. 8. That is, each CPU assigns tests to itself, and also performs the tests.

However, the above-mentioned embodiment may be modified as follows. That is, in this modified example, the server apparatus in FIG. 1 is provided with one control unit not illustrated in the attached drawings in addition to the SBs 0 and 1, and the control unit assigns tests to each of the CPUs 00 through 11. In this modified example, the control unit does not perform a test, and the CPUs 00 through 11 perform only the assigned tests. Therefore, it is not necessary to acquire or release the lock.

FIG. 1 exemplifies a hardware configuration of the server apparatus 30, but apparatuses to which the embodiments may be applied are not limited to the server apparatus 30 and/or a personal computer (PC) for a client. For example, the embodiments may be applied to a router device provided with a multiprocessor. For example, each processor provided for a router may function as the assignment device 100 and the testing unit 111 illustrated in FIG. 4.

In the above-mentioned embodiments, grouping tables having the same contents are stored in the SRAM 05 and the SRAM 15, the priority tables having the same contents are stored in the ROM 06 and the ROM 16, and the progress management table is distributively stored in the SRAM 05 and SRAM 15. However, these storage locations of these tables are merely described for an exemplary purpose.

It is not always necessary that each SB stores a grouping table and a priority table. And, it is not always necessary that a progress management table is distributed.

Furthermore, the grouping information 101, the priority information 102, the class information 103, and the progress information 104 may be represented by the data structure other than a table format although FIGS. 5 through 7 illustrate the grouping table, the priority table, and the progress management table as examples of the above kinds of information. In addition, the symbols used in the priority table and the progress management table are mere examples and other symbols or values may be used instead.

For example, in the priority table illustrated in FIG. 6, priorities are expressed by the symbol “x” or “blank”.

However, only the data corresponding to the cells marked with “x” in FIG. 6 may be stored as the priority information 102, and the absence of data may indicate the content corresponding to “blank” cells in FIG. 6.

In addition, the sequence of the items in each table illustrated in FIGS. 5 through 7 may be arbitrarily determined. It is obvious according to the descriptions with reference to FIGS. 8 through 11 that an appropriate assignment is made independent of the sequence of the items in these tables.

In the embodiments above, the POSTs are exemplified in the descriptions, but the embodiments may be applied to the testing processes other than the POSTs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a storage unit;
a plurality of testing units that execute a plurality of testing processes of the information processing apparatus;
a priority information read unit that reads priority information indicating a priority defined according to dependency among the plurality of testing processes in executing the plurality of testing processes from the storage unit;
a class information read unit that reads class information associating a class with each testing process and indicating a range of the testing unit or of the testing units to execute the associated testing process from the storage unit;
a progress information read unit that reads progress information indicating which testing process is uncompleted among the plurality of testing processes from the storage unit; and
an assignment unit that assigns an unexecuted testing process to any of the plurality of testing units according to the priority information, the class information, and the progress information, and that rewrites the progress information according to assignment of the unexecuted testing process.

2. The information processing apparatus according to claim 1, further comprising
a termination unit that rewrites the progress information to indicate that a first testing process has been completed, the rewriting occurring when one testing unit terminates the first testing process assigned to the one testing unit.

3. The information processing apparatus according to claim 1, wherein
the assignment unit simultaneously assigns two or more unexecuted testing processes in the plurality of testing processes to two or more of the plurality of testing units.

4. The information processing apparatus according to claim 1, wherein:
the progress information indicates which testing process has been completed, which testing process is being executed, and which testing process is unexecuted among the plurality of testing processes; and
the assignment unit rewrites the progress information to indicate that a second testing process is being executed, the rewriting occurring when one testing unit is executing the second testing process assigned to the one testing unit.

5. The information processing apparatus according to claim 1, further comprising
a grouping information read unit that reads grouping information from the storage unit, wherein for each class, the grouping information indicates one or more groups to which the plurality of testing units respectively belong,
the grouping information indicates a plurality of groups including a highest order group to which all of the plurality of testing units belong and a plurality of lowest order groups to each of which only one testing unit belongs, and
the assignment unit assigns an unexecuted third testing process to any of the plurality of testing units according to the priority information, the class information, and the grouping information.

6. A self-testing method of an information processing apparatus including a storage unit, comprising:
reading priority information indicating a priority defined according to dependency among a plurality of testing processes in executing the plurality of testing processes from the storage unit;
reading class information associating a class with each testing process and indicating a range of a testing unit or of testing units to execute the associated testing process from the storage unit;
reading progress information indicating which testing process is uncompleted among the plurality of testing processes from the storage unit;
assigning an unexecuted testing process to any of the plurality of testing units according to the priority information, the class information, and the progress information; and
rewriting the progress information according to the assigning of the unexecuted testing process.

7. The self-testing method according to claim 6, further comprising
rewriting the progress information to indicate that a first testing process has been completed, the rewriting occurring when the first testing process assigned to one testing unit terminates.

8. The self-testing method according to claim 6, wherein
in the assigning, two or more unexecuted testing processes in the plurality of testing processes are simultaneously assigned to two or more of the plurality of testing units.

9. The self-testing method according to claim 6, wherein:
the progress information indicates which testing process has been completed, which testing process is being executed, and which testing process is unexecuted among the plurality of testing processes; and
the progress information is rewritten in the rewriting to indicate that a second testing process is being executed, the rewriting occurring when one testing unit is executing the second testing process assigned to the one testing unit.

10. The self-testing method according to claim 6, further comprising:
reading grouping information from the storage unit, wherein
for each class, the grouping information indicates one or more groups to which the plurality of testing units respectively belong,
the grouping information indicates a plurality of groups including a highest order group to which all of the plurality of testing units belong and a plurality of lowest order groups to each of which only one testing unit belongs, and
in the assigning, an unexecuted third testing process is assigned to any of the plurality of testing units according to the priority information, the class information, and the grouping information.

11. A computer-readable storage medium storing a program used to direct an information processing apparatus including a storage unit to execute a process, the process comprising:
reading priority information indicating a priority defined according to dependency among a plurality of testing processes in executing the plurality of testing processes from the storage unit;
reading class information associating a class with each testing process and indicating a range of a testing unit or testing units to execute the associated testing process from the storage unit;
reading, progress information indicating which testing process is uncompleted among the plurality of testing processes from the storage unit;
assigning an unexecuted testing process to any of the plurality of testing units according to the priority information, the class information, and the progress information; and
rewriting the progress information according to the assigning of the unexecuted testing process.

12. The computer-readable storage medium according to claim 11, wherein the process further comprises:
rewriting the progress information to indicate that a first testing process has been completed, the rewriting occurring when the first testing process assigned to one testing unit terminates.

13. The computer-readable storage medium according to claim 11, wherein
in the assigning, two or more unexecuted testing processes in the plurality of testing processes are simultaneously assigned to two or more of the plurality of testing units.

14. The computer-readable storage medium according to claim 11, wherein:
the progress information indicates which testing process has been completed, which testing process is being executed, and which testing process is unexecuted among the plurality of testing processes; and
the progress information is rewritten in the rewriting to indicate that a second testing process is being executed, the rewriting occurring when one testing unit is executing the second testing process assigned to the one testing unit.

15. The computer-readable storage medium according to claim 11, wherein:
the process further comprises reading grouping information from the storage unit,
for each class, the grouping information indicates one or more groups to which the plurality of testing units respectively belong,
the grouping information indicates a plurality of groups including a highest order group to which all of the plurality of testing units belong and a plurality of lowest order groups to each of which only one testing unit belongs, and
in the assigning, an unexecuted third testing process is assigned to any of the plurality of testing units according to the priority information, the class information, and the grouping information.
